(19) United States
(12) Patent Application Publication
(10) Pub. No.: US 2013/0111102 A1
(43) Pub. Date: May 2, 2013

(54) SEMICONDUCTOR MEMORY DEVICES

(71) Applicant: JUNG-SIK KIM, Seoul (KR)

(72) Inventor: JUNG-SIK KIM, Seoul (KR)

(21) Appl. No.: 13/607,394

(22) Filed: Sep. 7, 2012

(30) Foreign Application Priority Data
Nov. 2, 2011 (KR) 10-2011-0113223

(51) Int. Cl. G06F 12/00

(52) U.S. Cl. 711/101; 711/E12.001

(57) ABSTRACT

A semiconductor memory device includes a selective data inversion unit and an inversion control unit. The selective data inversion unit inverts or maintains internal output data with a plurality of bits from a memory cell array to provide output data with a plurality of bits in response to an inversion control signal. The inversion control unit divides a number of bit changes between corresponding bits of a current internal output data and a previous output data immediately preceding the current internal output data into a plurality of groups, determines the number of bit changes in each group, and provides the inversion control signal indicating whether the number of bit changes is greater than half of data width of the current internal output data.

### CROSS-REFERENCE TO RELATED APPLICATION

This application claims under 35 USC §119 priority to and the benefit of Korean Patent Application No. 10-2011-0113223, filed on Nov. 2, 2011, in the Korean Intellectual Property Office (KIPO), the entire contents of which are incorporated by reference herein.

### BACKGROUND

1. Technical Field

The present disclosure relates generally to semiconductor devices, and, more particularly, to semiconductor memory devices.

2. Discussion of the Related Art

When semiconductor devices read or write data, the transition of bits of sequentially transmitted data occurs. Low-powered semiconductor memory devices, such as low voltage complementary metal oxide semiconductors (LVCMOS), and mobile systems need reduced circuit area and reduced power consumption.

### SUMMARY

In accordance with exemplary embodiments of the inventive concept semiconductor memory devices capable of reducing power consumption and occupied circuit area are provided.

Exemplary embodiments of semiconductor memory devices capable of performing on-chip data bit inversion are provided.

According to an exemplary embodiment, a semiconductor memory device includes a selective data inversion unit and an inversion control unit. The selective data inversion unit selectively either inverts or maintains internal output data with a plurality of bits from a memory cell array to provide output data with a plurality of bits in response to an inversion control signal. The inversion control unit divides a number of bit changes between corresponding bits of a current internal output data and a previous output data immediately preceding the current internal output data into a plurality of groups, determines the number of bit changes in each group, and provides the inversion control signal indicating whether the number of bit changes is greater than half of data width of the current internal output data.

In an exemplary embodiment the selective data inversion unit may invert the current internal output data to provide the output data when the inversion control signal indicates that the number of bit changes is greater than half of the data width of the current internal output data.

In an exemplary embodiment the selective data inversion unit may maintain the current internal output data to provide the output data when the inversion control signal indicates that the number of bit changes is not greater than half of the data width of the current internal output data.

In an exemplary embodiment the inversion control unit may include a comparison unit which compares the corresponding bits of the current internal output data and the previous output data to provide a plurality of comparison signals, each comparison signal indicating a change of the corresponding bits. An inversion control signal generator divides the plurality of comparison signals into the groups and is configured to determine the number of bit changes in each group to provide the inversion control signal.

Each of the groups may include two bits of the comparison signals. The inversion control signal generator may include a first group decision unit configured to provide a plurality of first group comparison signals which are enabled when at least one of each two bits of the comparison signals indicates that the corresponding bits are changed. A second group decision unit is configured to provide a plurality of second group comparison signals which are enabled when both of each two bits of the comparison signals indicate that the corresponding bits are changed. A first intermediate decision unit is configured to provide a plurality of first intermediate decision signals, each first intermediate decision signal being enabled when at least one of non-overlapped two of the first group comparison signals is high level. A second intermediate decision unit is configured to provide a plurality of second intermediate decision signals, each second intermediate decision signal being enabled when both of non-overlapped two of the second group comparison signals are high level. A first decision unit is configured to provide a first decision signal which is enabled when all of the first group comparison signals are high level and at least one of the second group comparison signals is high level. A second decision unit is configured to provide a second decision signal which is enabled when both of at least one pair of corresponding pairs of the first intermediate decision signals and the second intermediate decision signals are high level. An inversion control signal output unit is configured to provide the inversion control signal which is enabled when at least one of the first and second decision signals is high level.

The inversion control signal generator may provide the enabled inversion control signal when one bit of the two bits in each of the groups is changed and the other bit of the two bits in only one of the groups is changed.

The inversion control signal generator may provide the enabled inversion control signal when the two bits in only one of the groups are not changed and two bits in each of other groups except the only one are changed.

The inversion control signal generator may provide the enabled inversion control signal when the two bits in each of the groups are changed.

In an exemplary embodiment the semiconductor memory device may further include a flag output unit that buffers the inversion control signal to provide a flag signal.

In an exemplary embodiment the semiconductor memory device may further include a data output unit that provides the output data to a data pad.

According to an exemplary embodiment, a semiconductor memory device includes a memory cell array and a read circuit unit. The read circuit unit performs on-chip data bit inversion (DBI) on internal output data with a plurality of bits from the memory cell array on a read data bus between the memory cell array and a data pad to provide output data with a plurality of bits to the data pad.

In an exemplary embodiment the read circuit unit may include an inversion control unit configured to divide a number of bit changes between corresponding bits of a current internal output data and a previous intermediate output data immediately preceding the current internal output data into a plurality of groups, configured to determine the number of bit changes in each group, and configured to provide a flag signal indicating whether the number of bit changes is greater than half of data width of the current internal output data. A first selective data inversion unit is configured to invert or maintain the internal output data to provide the intermediate output data in response to the flag signal. A second selective data inversion unit is configured to invert or maintain the intermediate output data to provide the output data in response to the flag signal.

In an exemplary embodiment the semiconductor memory device may further include a write circuit unit which performs on-chip data bit inversion (DBI) on input data with a plurality of bits from the data pad on a write data bus between the data pad and a write circuit which writes date to the memory cell array, to provide internal input data to the write circuit. The write circuit unit may include an inversion control unit configured to divide a number of bit changes between corresponding bits of a current input data and a previous intermediate input data immediately preceding the current input data into a plurality of groups, configured to determine the number of bit changes in each group, and configured to provide a flag signal indicating whether the number of bit changes is greater than half of data width of the current input data. A first selective data inversion unit may be configured to selectively either invert or maintain the input data to provide intermediate input data in response to the flag signal. A second selective data inversion unit may be configured to selectively either invert or maintain the intermediate input data to provide the internal input data in response to the flag signal.

In an exemplary embodiment the semiconductor memory device may further include an address circuit unit which performs on-chip address bit inversion (ABI) on address signal with a plurality of bits from an address pad on an address bus between the address pad and a row/column driver which accesses the memory cell array, to provide internal address signal to the row/column driver. The address circuit unit may include an inversion control unit configured to divide a number of bit changes between corresponding bits of a current address signal and a previous intermediate address signal immediately preceding the current address signal into a plurality of groups, configured to determine the number of bit changes in each group, and configured to provide a flag signal indicating whether the number of bit changes is greater than half of address width of the current address signal. A first selective data inversion unit may be configured to invert or maintain the address signal to provide intermediate address signal in response to the flag signal. A second selective data inversion unit may be configured to invert or maintain the intermediate address signal to provide the internal address signal in response to the flag signal.

Accordingly, current consumption and occupied circuit size may be reduced by inverting or non-inverting based on the comparison of corresponding bits of current data and previous data.

### BRIEF DESCRIPTION OF THE DRAWINGS

Illustrative, non-limiting exemplary embodiments will be more clearly understood from the following detailed description taken in conjunction with the accompanying drawings.

FIG. 1 is block diagram illustrating a semiconductor memory device according to an exemplary embodiment.

FIG. 2 is a block diagram illustrating the flag output unit in FIG. 1 according to an exemplary embodiment.

FIG. 3 is a block diagram illustrating the data output unit in FIG. 1 according to an exemplary embodiment.

FIG. 4 is a block diagram illustrating the inversion control unit in FIG. 1 according to an exemplary embodiment.

FIG. 5 illustrates the comparison unit in FIG. 4 according to an exemplary embodiment.

FIG. 6 illustrates the inversion control signal generator in FIG. 4 according to an exemplary embodiment.

FIGS. 7 through 11 are tables illustrating various signals in FIGS. 4 through 6 according to the internal output data and the output data.

FIG. 12 illustrates the output data and the flag signal in the semiconductor memory device according to an exemplary embodiment.

FIG. 13 is a timing diagram of the output data and the flag signal in the semiconductor memory device according to an exemplary embodiment.

FIG. 14 illustrates the inversion control signal generator in FIG. 4 according to an exemplary embodiment.

FIG. 15 is block diagram illustrating a memory controller according to an exemplary embodiment.

FIG. 16 is a block diagram illustrating a memory system according to an exemplary embodiment.

FIG. 17 is block diagram illustrating a semiconductor memory device according to an exemplary embodiment.

FIG. 18 is a block diagram illustrating the inversion control unit in FIG. 17 according to an exemplary embodiment.

FIG. 19 illustrates the comparison unit in FIG. 18 according to an exemplary embodiment.

FIG. 20 illustrates the flag signal generator in FIG. 18 according to an exemplary embodiment.

FIG. 21 is block diagram illustrating a memory controller according to an exemplary embodiment.

FIG. 22 is a block diagram illustrating a mobile system according to an exemplary embodiment.

FIG. 23 is a block diagram illustrating a computing system according to an exemplary embodiment.

### DETAILED DESCRIPTION OF THE EXEMPLARY EMBODIMENTS

Various exemplary embodiments will be described more fully hereinafter with reference to the accompanying drawings. Throughout the drawings like numerals refer to like elements.

It will be understood that, although the terms first, second, third etc. may be used herein to describe various elements, these elements should not be limited by these terms.

These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

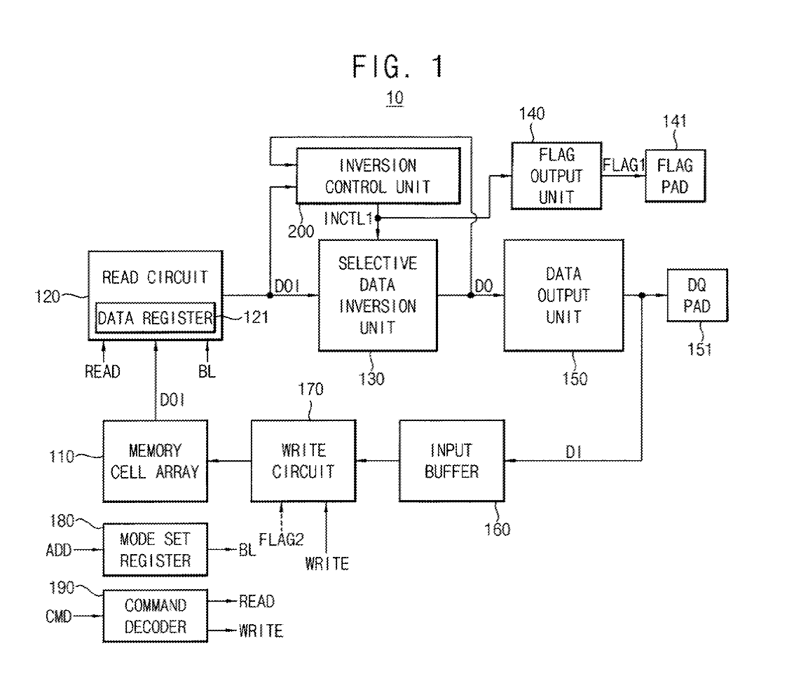

FIG. 1 is block diagram illustrating a semiconductor memory device according to an exemplary embodiment.

Referring to FIG. 1, a semiconductor memory device 10 includes a memory cell array 110, a read circuit 120, an inversion control unit 200, a selective data inversion unit 130, a flag output unit 140, a data output unit 150, an input buffer unit 160, a write circuit 170, a mode set register 180 and a command decoder 190.

The memory cell array 110 includes a plurality of memory cells storing data. The read circuit 120 includes a data register 121 and a data read operation circuit of the semiconductor memory device 10 (for example, a sense amplifier).

The read circuit 120 may perform a burst read operation that reads a predetermined number of internal output data DOI stored in the memory cell array 100 in parallel (or simultaneously) in response to a read signal READ and a burst length signal BL and may store the internal output data DOI read in parallel in the data register 121. For example, the data width of the internal output data DOI may be x8 and the number of internal output data DOI read in parallel may be 4 when the burst length signal BL signal indicates 4. The internal output data DOI stored in the data register 121 may be continuously (or sequentially) output to the selective data inversion unit 130.

The inversion control unit 200 generates an inversion control signal INCTL1 that determines whether the internal output data DOI that is continuously input to the selective data inversion unit 130 is inverted or not.

The inversion control unit 200 divides a number of bit changes between corresponding bits of a current internal output data DOI and a previous output data DO immediately preceding the current internal output data DOI into a plurality of groups, determines the number of bit changes in each group, and provides the inversion control signal INCTL1 indicating whether the number of bit changes is greater than half of data width of the current internal output data DOI. For example, the inversion control unit 200 may provide to the selective data inversion unit 130 the inversion control signal INCTL1 with a high level, when the number of bit changes in each group is greater than the data width of the internal output data DOI. In addition, the inversion control unit 200 may provide to the selective data inversion unit 130 the inversion control signal INCTL1 with a low level, when the number of bit changes in each group is not greater than the data width of the internal output data DOI.

The selective data inversion unit 130 selectively either inverts or maintains (non-inverts) the current internal output data DOI continuously provided from the memory cell array 120 in response to the inversion control signal INCTL1 to provide the output data DO continuously. For example, the selective data inversion unit 130 inverts the current internal output data DOI continuously provided from the memory cell array 120 in response to the inversion control signal INCTL1 to provide the output data DO continuously when the inversion control signal INCTL1 is a high level. In addition, the selective data inversion unit 130 maintains the current internal output data DOI continuously provided from the memory cell array 120 in response to the inversion control signal INCTL1 to provide the output data DO continuously when the inversion control signal INCTL1 is a low level.

The flag output unit 140 may output a flag signal FLAG1 indicating whether the output data DO is inverted or not in response to the inversion control signal INCTL1. For example, the flag signal FLAG1 may indicate that the output data DO is inverted when the flag signal FLAG1 has a high level and may indicate that the output data DO has not been inverted when the flag signal FLAG1 has a low level.

The data output unit 150 may drive DQ pads 151 according to LVCMOS signaling based on the output data DO continuously output from the selective data inversion unit 130.

The input buffer unit 160 may buffer input data DI continuously transmitted from a memory controller and may output the buffered input data to the write circuit 170. When the data width of the input data DI is x8, for example, the input buffer unit 160 may include eight input buffers corresponding to the data width of the input data DI.

The write circuit 170 may include a circuit related to a data write operation of the semiconductor memory device 10 (for example, an input driver). The write circuit 170 may perform a burst write operation that writes input data DI output from the input buffer unit 160 in parallel to the memory cell array 110 in response to a write signal WRITE. In addition, the write circuit 170 may further include a selective data inversion unit which inverts or non-inverts the input data DI from the input buffer unit 160.

The mode set register 180 may generate the burst length signal BL in response to an address signal ADD provided by the memory controller. The command decoder 190 may generate the read signal READ and the write signal WRITE synchronized with the clock signal in response to a command signal CMD provided by the memory controller.

FIG. 2 is a block diagram illustrating an example of the flag output unit in FIG. 1.

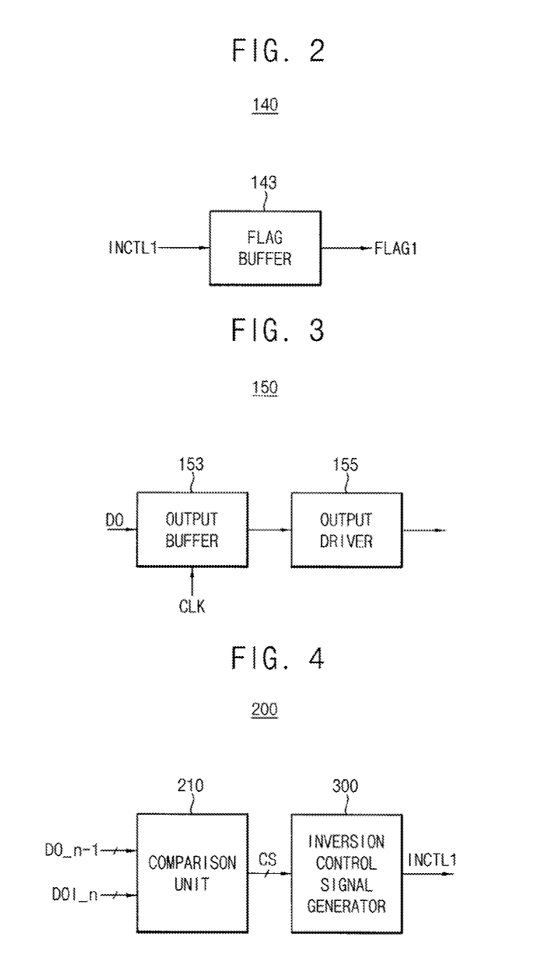

Referring to FIG. 3, the flag output unit 140 includes a flag buffer 143. The flag buffer 143 provides the flag signal FLAG1 to the flag pad 141 in response to the inversion control signal INCTL1. The flag pad 141 may be included in the flag output unit 140.

FIG. 3 is a block diagram illustrating an example of the data output unit in FIG. 1.

Referring to FIG. 3, the data output unit 150 may include an output buffer 153 and an output driver 155.

The output buffer 153 receives the output data DO to provide the output data DO to the output driver 155. The output data DO may be provided to the output buffer 153 in synchronization with a clock signal CLK. The output driver 155 receives the output data DO from the output buffer 153 and drives the DQ pads 151 according to LVCMOS signaling.

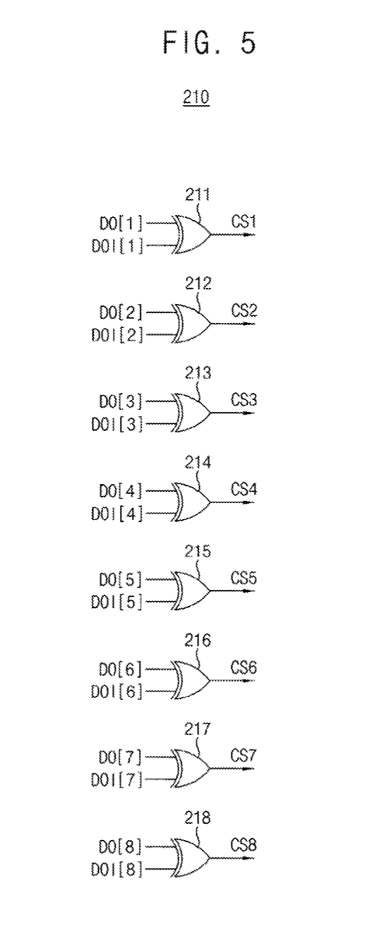

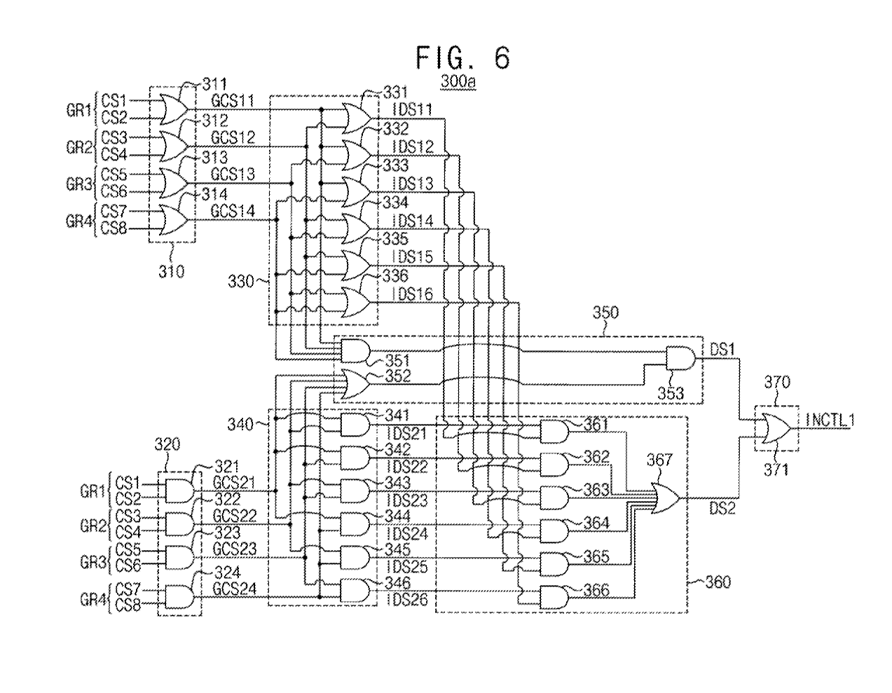

FIG. 4 is a block diagram illustrating an example of the inversion control unit in FIG. 1.

Referring to FIG. 4, the inversion control unit 200 includes a comparison unit 210 and an inversion control signal generator 300.

The comparison unit 210 compares the corresponding bits of the current internal output data DOI_n and the previous output data DO_n−1 to provide a plurality of comparison signals CS and each of the comparison signals CS indicates a change of the corresponding bits of the current internal output data DOI_n and the previous output data DO_n−1. The inversion control signal generator 300 receives the comparison signals CS, divides the comparison signals CS into a plurality of groups by predetermined bits (for example, two bits) and determines the number of bit changes in each group to provide the inversion control signal INCTL1.

Hereinafter, it is assumed that the internal output data DOI and the output data DO include 8 bits respectively.

FIG. 5 illustrates an example of the comparison unit in FIG. 4.

Referring to FIG. 5, the comparison unit 210 may include a plurality of exclusive OR gates 211, 212, 213, 214, 215, 216, 217, 218.

The exclusive OR gate 211 performs exclusive OR operation on current internal output data DOI[1] and the previous output data DO[1] to provide a comparison signal CS1. The exclusive OR gate 212 performs exclusive OR operation on current internal output data DOI[2] and the previous output data DO[2] to provide a comparison signal CS2. The exclusive OR gate 213 performs exclusive OR operation on current internal output data DOI[3] and the previous output data DO[3] to provide a comparison signal CS3. The exclusive OR gate 214 performs exclusive OR operation on current internal output data DOI[4] and the previous output data DO[4] to provide a comparison signal CS4. The exclusive OR gate 215 performs exclusive OR operation on current internal output data DOI[5] and the previous output data DO[5] to provide a comparison signal CS5. The exclusive OR gate 216 performs exclusive OR operation on current internal output data DOI[6] and the previous output data DO[6] to provide a comparison signal CS6. The exclusive OR gate 217 performs exclusive OR operation on current internal output data DOI[7] and the previous output data DO[7] to provide a comparison signal CS7. The exclusive OR gate 218 performs exclusive OR operation on current internal output data DOI[8] and the previous output data DO[8] to provide a comparison signal CS8. Therefore, each of the comparison signals CS1, CS2, CS3, CS4, CS5, CS6, CS7, CS8 may have a high level when the corresponding bits of the current internal output data DOI_n and the previous output data DO_n−1 are changed and may have a low level when the corresponding bits of the current internal output data DOI_n and the previous output data DO_n−1 are not changed.

FIG. 6 illustrates an example of the inversion control signal generator in FIG. 4.

Referring to FIG. 6, an inversion control signal generator 300a may include a first group decision unit 310, a second group decision unit 320, a first intermediate decision unit 330, a second intermediate decision unit 340, a first decision unit 350, a second decision unit 360 and an inversion control signal output unit 370.

A group GR1 includes two comparison signals CS1, CS2, a group GR2 includes two comparison signals CS3, CS4, a group GR3 includes two comparison signals CS5, CS6, and a group GR4 includes two comparison signals CS7, CS8. That is, each of the groups GR1, GR2, GR3, GR4 include two bits of the comparison signals CS1, CS2, CS8.

The first group decision unit 310 includes OR gates 311, 312, 313, 314. The OR gate 311 performs OR operation on the comparison signals CS1, CS2 to provide a group comparison signal GCS11. The OR gate 312 performs OR operation on the comparison signals CS3, CS4 to provide a group comparison signal GCS12. The OR gate 313 performs OR operation on the comparison signals CS5, CS6 to provide a group comparison signal GCS13. The OR gate 314 performs OR operation on the comparison signals CS7, CS8 to provide a group comparison signal GCS14. Therefore, each of the first group comparison signals GCS11, GCS12, GCS13, GCS14 may have a high level when at least one of each two bits of the comparison signals CS1, CS2, the comparison signals CS3, CS4, the comparison signals CS5, CS6 and the comparison signals CS7, CS8 has a high level. That is, each of the first group comparison signals GCS11, GCS12, GCS13, GCS14 may be enabled when at least one of each two bits of the comparison signals CS1, CS2, the comparison signals CS3, CS4, the comparison signals CS5, CS6 and the comparison signals CS7, CS8 indicates that the corresponding bits are changed.

The second group decision unit 320 includes AND gates 321, 322, 323, 324. The AND gate 321 performs an AND operation on the comparison signals CS1, CS2 to provide a group comparison signal GCS21. The AND gate 322 performs an AND operation on the comparison signals CS3, CS4 to provide a group comparison signal GCS22. The AND gate 323 performs an AND operation on the comparison signals CS5, CS6 to provide a group comparison signal GCS23. The AND gate 324 performs an AND operation on the comparison signals CS7, CS8 to provide a group comparison signal GCS24. Therefore, each of the second group comparison signals GCS21, GCS22, GCS23, GCS24 may have a high level when both of each two bits of the comparison signals CS1, CS2, the comparison signals CS3, CS4, the comparison signals CS5, CS6 and the comparison signals CS7, CS8 has a high level. That is, each of the second group comparison signals GCS21, GCS22, GCS23, GCS24 may be enabled when both of each two bits of the comparison signals CS1, CS2, the comparison signals CS3, CS4, the comparison signals CS5, CS6 and the comparison signals CS7, CS8 indicates that the corresponding bits are changed.

The first intermediate decision unit 330 includes OR gates 331, 332, 333, 334, 335, 336. The OR gate 331 performs OR operation on the group comparison signals GCS11, GCS12 to provide an intermediate decision signal IDS11. The OR gate 332 performs OR operation on the group comparison signals GCS11, GCS13 to provide an intermediate decision signal IDS12. The OR gate 333 performs OR operation on the group comparison signals GCS11, GCS14 to provide an intermediate decision signal IDS13. The OR gate 334 performs OR operation on the group comparison signals GCS12, GCS13 to provide an intermediate decision signal IDS14. The OR gate 335 performs OR operation on the group comparison signals GCS12, GCS14 to provide an intermediate decision signal IDS15. The OR gate 336 performs OR operation on the group comparison signals GCS13, GCS14 to provide an intermediate decision signal IDS16. That is, first intermediate decision unit 330 provides the first intermediate decision signals IDS11, IDS12, IDS13, IDS14, IDS15, IDS16, and each of the first intermediate decision signals IDS11, IDS12, IDS13, IDS14, IDS15, IDS16 is enabled when at least one of non-overlapped two of the first group comparison signals GCS11, GCS12, GCS13, GCS14 is high level.

The second intermediate decision unit 340 includes AND gates 341, 342, 343, 344, 345, 346. The AND gate 341 performs an AND operation on the group comparison signals GCS21, GCS22 to provide an intermediate decision signal IDS21. The AND gate 342 performs an AND operation on the group comparison signals GCS21, GCS23 to provide an intermediate decision signal IDS22. The AND gate 343 performs an AND operation on the group comparison signals GCS21, GCS24 to provide an intermediate decision signal IDS23. The AND gate 344 performs an AND operation on the group comparison signals GCS22, GCS23 to provide an intermediate decision signal IDS24. The AND gate 345 performs an AND operation on the group comparison signals GCS22, GCS24 to provide an intermediate decision signal IDS25. AND gate 346 performs an AND operation on the group comparison signals GCS23, GCS24 to provide an intermediate decision signal IDS26. That is, second intermediate decision unit 340 provides the second intermediate decision signals IDS21, IDS22, IDS23, IDS24, IDS25, IDS26, and each of the second intermediate decision signals IDS21, IDS22, IDS23, IDS24, IDS25, IDS26 is enabled when both of non-overlapped two of the second group comparison signals GCS21, GCS22, GCS23, GCS24 are high level.

The first decision unit 350 includes AND gates 351, 353 and OR gate 352. The AND gate 351 performs an AND operation on the first group comparison signals GCS11, GCS12, GCS13, GCS14. The OR gate 352 performs OR operation on the second group comparison signals GCS21, GCS22, GCS23, GCS24. The AND gate 353 performs an AND operation on outputs of the AND gate 351 and the OR gate 352 to provide a first decision signal DS1. Therefore, the first decision unit 350 provides a first decision signal DS1 which are enabled when all of the first group comparison signals GCS11, GCS12, GCS13, GCS14 are high level and at least one of the second group comparison signals GCS21, GCS22, GCS23, GCS24 is high level.

The second decision unit 360 includes AND gates 361, 363, 364, 365, 366 and OR gate 367. The AND gate 361 performs an AND operation on corresponding intermediate decision signals IDS11, IDS21. The AND gate 362 performs an AND operation on corresponding intermediate decision signals IDS12, IDS22. The AND gate 363 performs an AND operation on corresponding intermediate decision signals IDS13, IDS23. The AND gate 364 performs an AND operation on corresponding intermediate decision signals IDS14, IDS24. The AND gate 365 performs an AND operation on corresponding intermediate decision signals IDS15, IDS25. The AND gate 366 performs an AND operation on corresponding intermediate decision signals IDS16, IDS26. The OR gate 367 performs OR operation on outputs of the AND gates 361, 362, 363, 364, 365, 366 to provide a second decision signal DS2. Therefore, the second decision unit 360 provides the second decision signal DS2 which is enabled when both of at least one pair of corresponding pairs IDS11, IDS21, pairs IDS12, IDS22, pairs IDS13, IDS23, pairs IDS14, IDS24, pairs IDS15, IDS25 and pairs IDS16, IDS26 of the first intermediate decision signals IDS11, IDS12, IDS13, IDS14, IDS15, IDS16 and the second intermediate decision signals IDS21, IDS22, IDS23, IDS24, IDS25, IDS26 are high level.

The inversion signal output unit 370 includes an OR gate 371. The OR gate 371 performs OR operation on the first and second decision signals DS1, DS2 to provide the inversion control signal INCTL1. That is, the inversion signal output unit 370 provides the inversion control signal INCTL1 which is enabled when at least one of the first and second decision signals DS1, DS2 is high level.

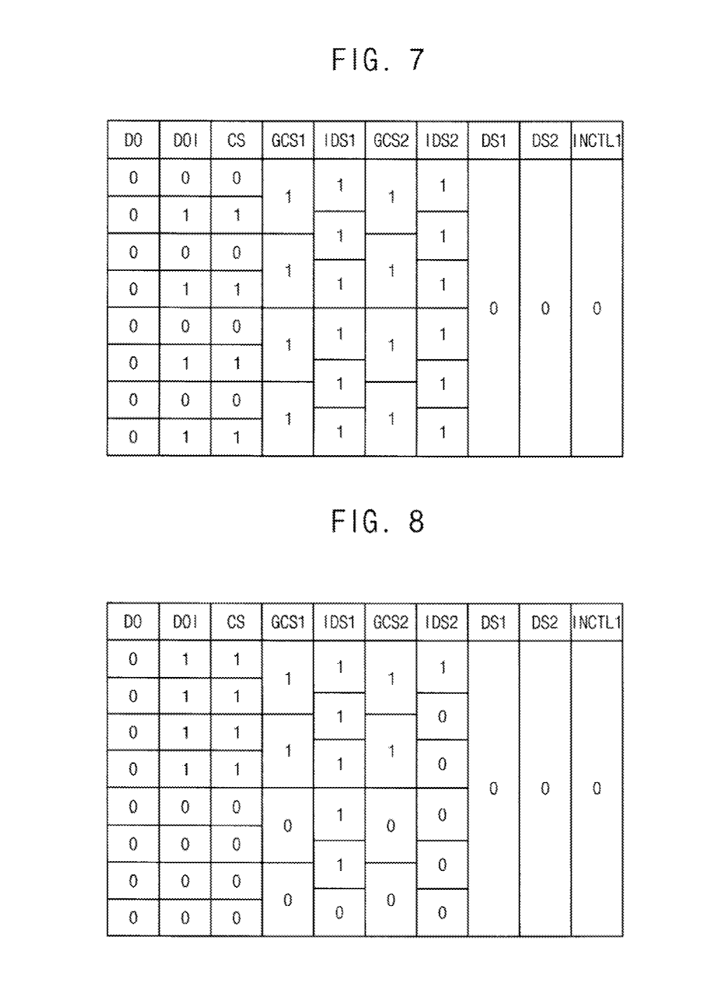

FIGS. 7 through 11 are tables illustrating various signals in FIGS. 4 through 6 according to the internal output data and the output data.

In FIGS. 7 through 11, it is assumed that the previous output data DO are ‘000000000’.

Referring to FIG. 7, when the previous output data DO are ‘00000000’ and the current internal output data DOI are ‘01010101’, the comparison signals CS correspond to ‘01010101’. In FIG. 7, only one bit in each group including two comparison signals is changed. Therefore, the number of bit changes between the corresponding bits of the previous output data DO and the current internal output data DOI is four. In addition, the first group comparison signals GCS1 correspond to ‘1111’, and thus, the first intermediate decision signals IDS1 correspond to ‘111111’. In addition, the second group comparison signals GCS2 correspond to ‘1111’, and thus, the second intermediate decision signals IDS2 correspond to ‘111111’. Therefore, the first decision signal DS1 corresponds to ‘0’ and the second decision signal DS2 corresponds to ‘0’. As a result, the inversion control signal INCTL1 corresponds to ‘0’. That is, the inversion control signal INCTL1 is disabled. That is, when the number of bit changes between the corresponding bits of the previous output data DO and the current internal output data DOI is four (that is the number of bit changes is not greater than half of the data width of the internal output data DOI), the inversion control signal INCTL1 is disabled, and thus, the selective data inversion unit 130 maintains (non-inverts) the internal output data DOI to provide the output data DO.

Referring to FIG. 8, when the previous output data DO are ‘00000000’ and the current internal output data DOI are ‘11110000’, the comparison signals CS correspond to ‘11110000’. In FIG. 8, both bits in two groups, each including two comparison signals, are changed and both bits in other two groups, each including two comparison signals, are not changed. Therefore, the number of bit changes between the corresponding bits of the previous output data DO and the current internal output data DOI is four. In addition, the first group comparison signals GCS1 correspond to ‘1100’, and thus, the first intermediate decision signals IDS1 correspond to ‘111110’. In addition, the second group comparison signals GCS2 correspond to ‘1100’, and thus, the second intermediate decision signals IDS2 correspond to ‘100000’. Therefore, the first decision signal DS1 corresponds to ‘0’ and the second decision signal DS2 corresponds to ‘0’. As a result, the inversion control signal INCTL1 corresponds to ‘0’. That is, the inversion control signal INCTL1 is disabled. That is, when the number of bit changes between the corresponding bits of the previous output data DO and the current internal output data DOI is four (that is the number of bit changes is not greater than half of the data width of the internal output data DOI), the inversion control signal INCTL1 is disabled, and thus, the selective data inversion unit 130 maintains (non-inverts) the internal output data DOI to provide the output data DO.

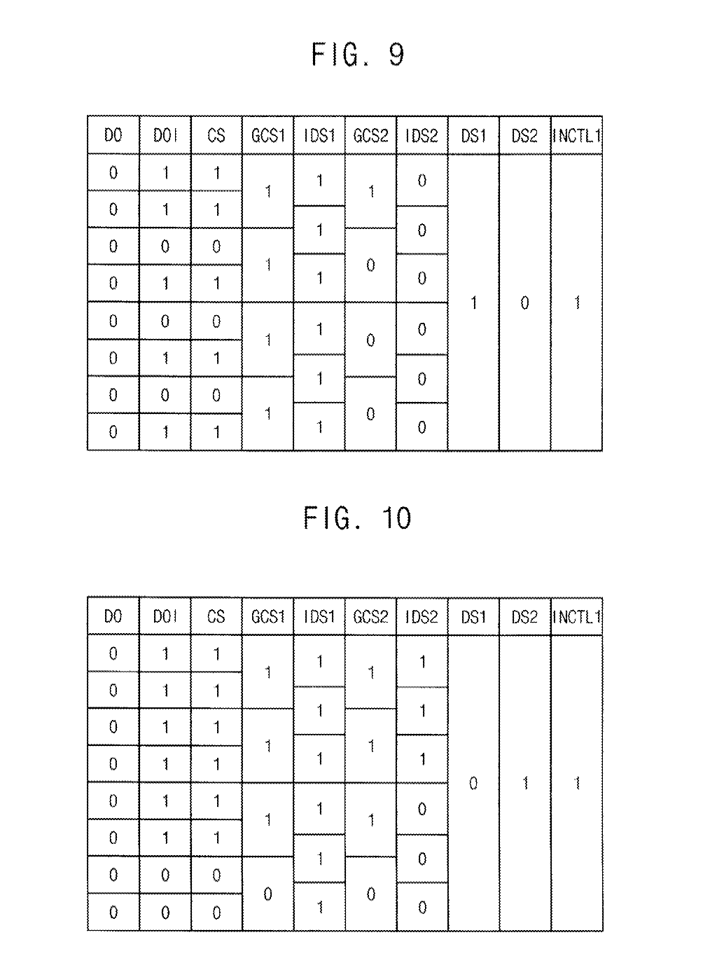

Referring to FIG. 9, when the previous output data DO are ‘00000000’ and the current internal output data DOI are ‘11010101’, the comparison signals CS correspond to ‘11010101’. In FIG. 9, one bit in four groups, each including two comparison signals, is changed and another bit in one of the four groups, is also changed. Therefore, the number of bit changes between the corresponding bits of the previous output data DO and the current internal output data DOI is five. In addition, the first group comparison signals GCS1 correspond to ‘1111’, and thus, the first intermediate decision signals IDS1 correspond to ‘111111’. In addition, the second group comparison signals GCS2 correspond to ‘1000’, and thus, the second intermediate decision signals IDS2 correspond to ‘000000’. Therefore, the first decision signal DS1 corresponds to ‘1’ and the second decision signal DS2 corresponds to ‘0’. As a result, the inversion control signal INCTL1 corresponds to ‘1’. That is, the inversion control signal INCTL1 is enabled. That is, when the number of bit changes between the corresponding bits of the previous output data DO and the current internal output data DOI is five (that is the number of bit changes is greater than half of the data width of the internal output data DOI), the inversion control signal INCTL1 is enabled, and thus, the selective data inversion unit 130 inverts the internal output data DOI to provide the output data DO.

Referring to FIG. 10, when the previous output data DO are ‘00000000’ and the current internal output data DOI are ‘11111100’, the comparison signals CS correspond to ‘11111100’. In FIG. 10, both bits in three of four groups, each including two comparison signals, are changed and both bits in one of the four groups, are not changed. Therefore, the number of bit changes between the corresponding bits of the previous output data DO and the current internal output data DOI is six. In addition, the first group comparison signals GCS1 correspond to ‘1110’, and thus, the first intermediate decision signals IDS1 correspond to ‘111111’. In addition, the second group comparison signals GCS2 correspond to ‘1110, and thus, the second intermediate decision signals IDS2 correspond to ‘111000’. Therefore, the first decision signal DS1 corresponds to ‘0’ and the second decision signal DS2 corresponds to ‘1’. As a result, the inversion control signal INCTL1 corresponds to ‘1’. That is, the inversion control signal INCTL1 is enabled. That is, when the number of bit changes between the corresponding bits of the previous output data DO and the current internal output data DOI is six (that is the number of bit changes is greater than half of the data width of the internal output data DOI), the inversion control signal INCTL1 is enabled, and thus, the selective data inversion unit 130 inverts the internal output data DOI to provide the output data DO.

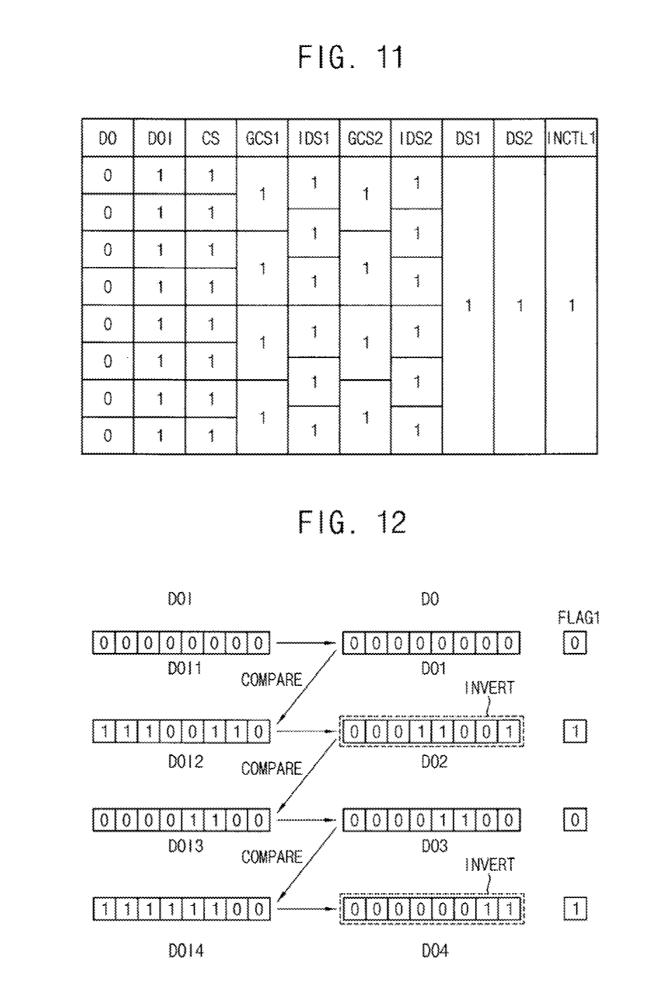

Referring to FIG. 11, when the previous output data DO are ‘00000000’ and the current internal output data DOI are ‘11111111’, the comparison signals CS correspond to ‘11111111’. In FIG. 11, both bits in four groups, each including two comparison signals, are changed. Therefore, the number of bit changes between the corresponding bits of the previous output data DO and the current internal output data DOI is eight. In addition, the first group comparison signals GCS1 correspond to ‘1111’, and thus, the first intermediate decision signals IDS1 correspond to ‘111111’. In addition, the second group comparison signals GCS2 correspond to ‘1111, and thus, the second intermediate decision signals IDS2 correspond to ‘111111’. Therefore, the first decision signal DS1 corresponds to ‘1’ and the second decision signal DS2 corresponds to ‘1’. As a result, the inversion control signal INCTL1 corresponds to ‘1’. That is, the inversion control signal INCTL1 is enabled. That is, when the number of bit changes between the corresponding bits of the previous output data DO and the current internal output data DOI is eight (that is the number of bit changes is greater than half of the data width of the internal output data DOI), the inversion control signal INCTL1 is enabled, and thus, the selective data inversion unit 130 inverts the internal output data DOI to provide the output data DO.

In addition, when the number of bit changes between the corresponding bits of the previous output data DO and the current internal output data DOI is 0, 1, 2 or 3 (that is, the number of bit changes is smaller than half of the data width of the internal output data DOI), the first decision signal DS1 corresponds to ‘0’ and the second decision signal DS2 corresponds to ‘0’. As a result, the inversion control signal INCTL1 corresponds to ‘0’. That is, the inversion control signal INCTL1 is disabled.

In addition, when the number of bit changes between the corresponding bits of the previous output data DO and the current internal output data DOI is 7 (that is, the number of bit changes is greater than half of the data width of the internal output data DOI), the first decision signal DS1 corresponds to ‘0’ and the second decision signal DS2 corresponds to ‘1’. As a result, the inversion control signal INCTL1 corresponds to T.

That is, the inversion control signal INCTL1 is enabled.

FIG. 12 illustrates an example of the output data and the flag signal in the semiconductor memory device.

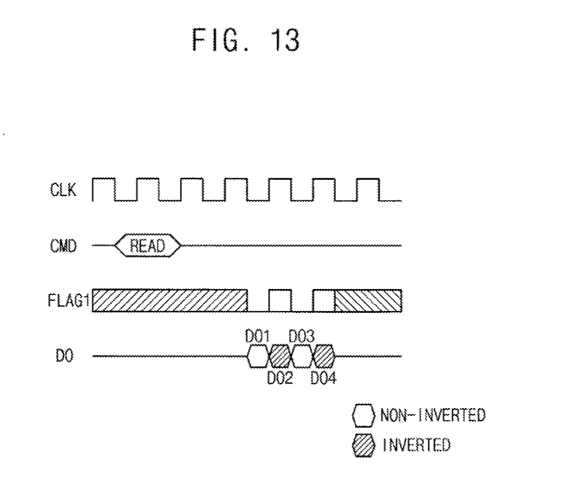

FIG. 13 is a timing diagram of the output data and the flag signal in the semiconductor memory device according to an exemplary embodiment.

In FIGS. 12 and 13, the data width of the internal output data DOI is x8 and the burst length of the internal output data DOI is 4. The flag signal FLAG1 may correspond to the inversion control signal INCTL1.

Referring to FIGS. 12 and 13, four units of internal output data DOI1, DOI2, DOI3, DOI4 (each including 8 bits) that are read in parallel from the memory cell array 100 are sequentially output by the data register 121 to the selective data inversion unit 130.

The first internal output data unit DOI1, “00000000”, received by the selective data inversion unit 130 is compared with the output data DO (not shown) (for example, “00000001”) immediately proceeding the first internal output data DOI1 bit by bit. Hence, the number of bit changes of the corresponding bits of the first internal output data DOI1 and the previous output data is one. Since the number of bit changes of the corresponding bits is less than half of the data width of the internal output data unit DOI, the first internal output data unit DOI1 is not inverted and “00000000” is output as first output data DO1. The flag signal FLAG1 signal corresponding to the first output data DO1 has a data value of “0” because the first output data DO1 has not been inverted.

The second internal output data unit DOI2, “11100110”, received by the selective data inversion unit 130 is compared with the first output data DO1, “00000000”, immediately proceeding the second internal output data DOI2 bit by bit. Hence, the number of bit changes of the corresponding bits of the second internal output data DOI2 and the first output data DO1 is five. Since the number of bit changes of the corresponding bits (i.e., 5) is greater than half of the data width of the internal output data unit DOI, the second internal output data unit DOI2 is inverted and “00011001” is output as second output data DO2. The flag signal FLAG1 signal corresponding to the second output data DO2 has a data value of “1” because the second output data DO2 has been inverted.

The third internal output data unit DOI3, “0001100”, received by the selective data inversion unit 130 is compared with the second output data DO2, “00011001” immediately proceeding the third internal output data DOI3 bit by bit. Hence, the number of bit changes of the corresponding bits of the third internal output data DOI3 and the second output data DO2 is three. Since the number of bit changes of the corresponding bits (i.e., 3) is less than half of the data width of the internal output data unit DOI, the third internal output data unit DOI3 is not inverted and “00001100” is output as third output data DO3. The flag signal FLAG1 signal corresponding to the third output data DO3 has a data value of “0” because the third output data DO3 has not been inverted.

The fourth internal output data unit DOI4, “11111100”, received by the selective data inversion unit 130 is compared with the second output data DO3, “00001100” immediately proceeding the fourth internal output data DOI4 bit by bit. Hence, the number of bit changes of the corresponding bits of the fourth internal output data DOI4 and the third output data DO3 is five. Since the number of bit changes of the corresponding bits (i.e., 5) is greater than half of the data width of the internal output data unit DOI, the fourth internal output data unit DOI4 is inverted and “00000011” is output as fourth output data DO4. The flag signal FLAG1 signal corresponding to the fourth output data DO4 has a data value of “1” because the fourth output data DO4 has been inverted.

Referring to FIG. 13, the read signal READ that dictates the burst read operation is synchronized with the clock signal CLK and both may be applied to the semiconductor memory device 10 such as a double data rate synchronous DRAM from a memory controller. Then, the first to fourth output data DO1, DO2, DO3, DO4 and the flag signal FLAG1 may be continuously output in synchronization with a falling edge and a rising edge of the clock signal CLK.

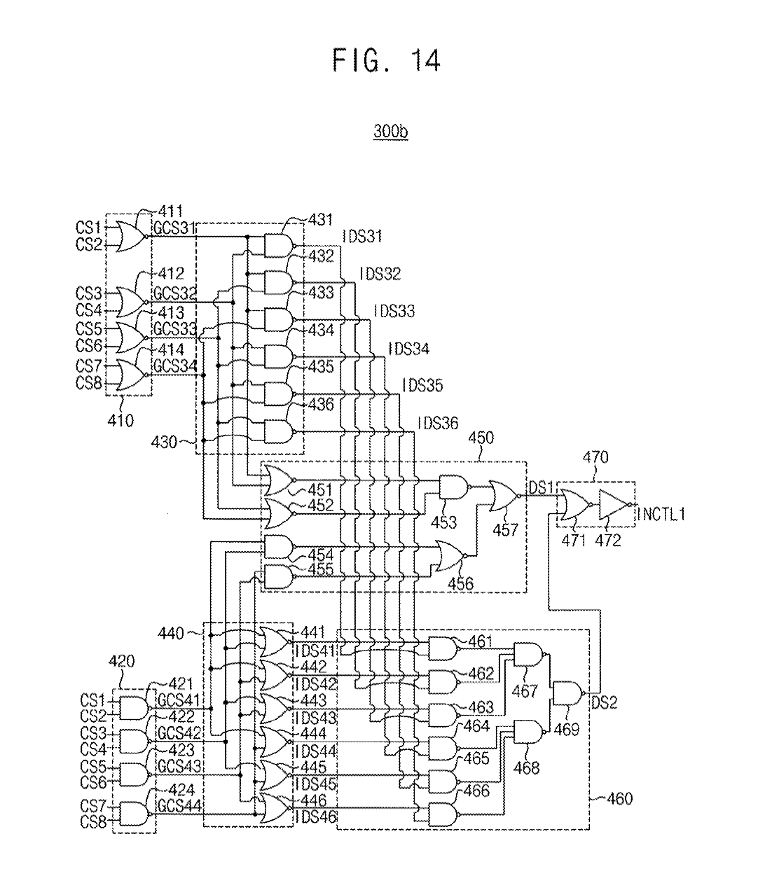

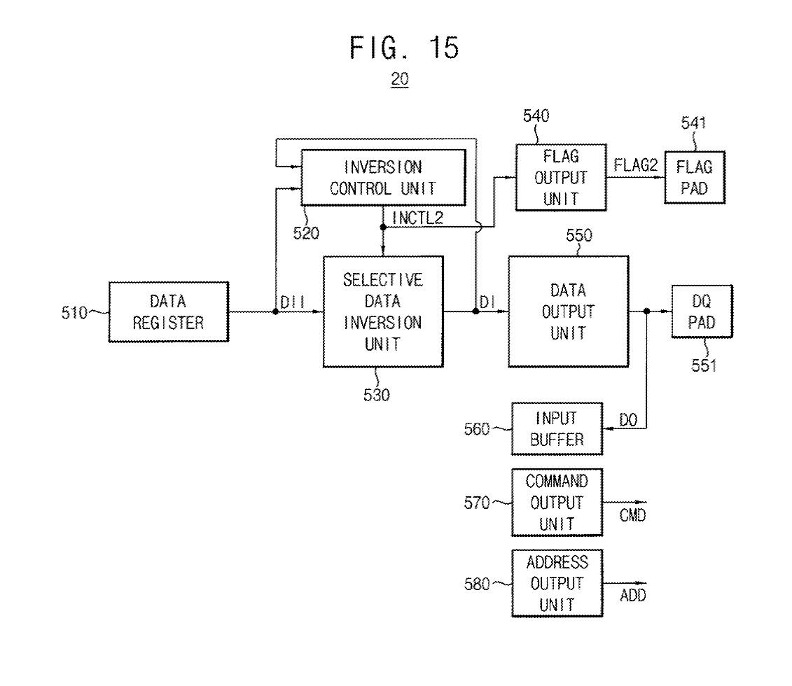

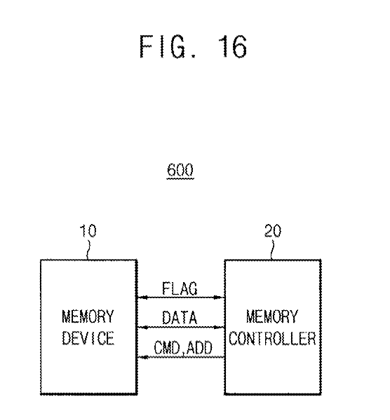

FIG. 14 illustrates another example of the inversion control signal generator in FIG. 4.

Referring to FIG. 14, an inversion control signal generator 300b may include a first group decision unit 410, a second group decision unit 420, a first intermediate decision unit 430, a second intermediate decision unit 440, a first decision unit 450, a second decision unit 460 and an inversion control signal output unit 470.

A group GR1 includes two comparison signals CS1, CS2, a group GR2 includes two comparison signals CS3, CS4, a group GR3 includes two comparison signals CS5, CS6, and a group GR4 includes two comparison signals CS7, CS8. That is, each of the groups GR1, GR2, GR3, GR4 include two bits of the comparison signals CS1, CS2, CS3, CS4, CS5, CS6, CS7, CS8.

The first group decision unit 410 includes NOR gates 411, 412, 413, 414. The NOR gate 411 performs a NOR operation on the comparison signals CSI, CS2 to provide a group comparison signal GCS31. The NOR gate 412 performs a NOR operation on the comparison signals CS3, CS4 to provide a group comparison signal GCS32. The NOR gate 413 performs a NOR operation on the comparison signals CS5, CS6 to provide a group comparison signal GCS33. The NOR gate 314 performs a NOR operation on the comparison signals CS7, CS8 to provide a group comparison signal GCS44. Therefore, each of the third group comparison signals GCS11, GCS12, GCS13, GCS14 may have a high level when at least one of each two bits of the comparison signals CSI, CS2, the comparison signals CS3, CS4, the comparison signals CS5, CS6 and the comparison signals CS7, CS8 has a high level. That is, each of the third group comparison signals GCS31, GCS32, GCS33, GCS34 may be enabled when at least one of each two bits of the comparison signals CS1, CS2, the comparison signals CS3, CS4, the comparison signals CS5, CS6 and the comparison signals CS7, CS8 indicates that the corresponding bits are changed.

The second group decision unit 420 includes NAND gates 421, 422, 423, 424. The NAND gate 421 performs a NAND operation on the comparison signals CS1, CS2 to provide a group comparison signal GCS41. The NAND gate 422 performs a NAND operation on the comparison signals CS3, CS4 to provide a group comparison signal GCS42. The NAND gate 423 performs a NAND operation on the comparison signals CS5, CS6 to provide a group comparison signal GCS43. The NAND gate 424 performs a NAND operation on the comparison signals CS7, CS8 to provide a group comparison signal GCS44. Therefore, each of the fourth group comparison signals GCS41, GCS42, GCS43, GCS44 may have a high level when both of each two bits of the comparison signals CS1, CS2, the comparison signals CS3, CS4, the comparison signals CS5, CS6 and the comparison signals CS7, CS8 has a high level. That is, each of the fourth group comparison signals GCS41, GCS42, GCS43, GCS44 may be enabled when both of each two bits of the comparison signals CS1, CS2, the comparison signals CS3, CS4, the comparison signals CS5, CS6 and the comparison signals CS7, CS8 indicates that the corresponding bits are changed.

The first intermediate decision unit 430 includes NAND gates 431, 432, 433, 434, 435, 436. The NAND gate 431 performs a NAND operation on the group comparison signals GCS31, GCS32 to provide an intermediate decision signal. IDS31. The NAND gate 432 performs a NAND operation on the group comparison signals GCS31, GCS33 to provide an intermediate decision signal IDS32. The NAND gate 433 performs a NAND operation on the group comparison signals GCS31, GCS34 to provide an intermediate decision signal IDS33. The NAND gate 434 performs a NAND operation on the group comparison signals GCS32, GCS33 to provide an intermediate decision signal IDS44. The NAND gate 435 performs a NAND operation on the group comparison signals GCS32, GCS34 to provide an intermediate decision signal IDS35. The NAND gate 436 performs a NAND operation on the group comparison signals GCS33, GCS34 to provide an intermediate decision signal IDS36. That is, the first intermediate decision unit 430 provides the third intermediate decision signals IDS31, IDS32, IDS33, IDS34, IDS35, IDS36, and each of the third intermediate decision signals IDS31, IDS32, IDS33, IDS34, IDS35, IDS36 is enabled when both of non-overlapped two of the third group comparison signals GCS31, GCS32, GCS33, GCS34 is high level.

The second intermediate decision unit 440 includes NOR gates 441, 442, 443, 444, 445, 446. The NOR gate 341 performs a NOR operation on the group comparison signals GCS21, GCS22 to provide an intermediate decision signal IDS41. The NOR gate 342 performs a NOR operation on the group comparison signals GCS41, GCS43 to provide an intermediate decision signal IDS42. The NOR gate 443 performs a NOR operation on the group comparison signals GCS41, GCS44 to provide an intermediate decision signal IDS43. The NOR gate 444 performs a NOR operation on the group comparison signals GCS42, GCS43 to provide an intermediate decision signal IDS44. The NOR gate 445 performs a NOR operation on the group comparison signals GCS42, GCS44 to provide an intermediate decision signal IDS45. The NOR gate 446 performs NOR operation on the group comparison signals GCS43, GCS44 to provide an intermediate decision signal IDS46. That is, second intermediate decision unit 440 provides the fourth intermediate decision signals IDS41, IDS42, IDS43, IDS44, IDS45, IDS46, and each of the fourth intermediate decision signals IDS41, IDS42, IDS43, IDS44, IDS45, IDS46 is enabled when at least one of non-overlapped two of the fourth group comparison signals GCS41, GCS42, GCS43, GCS44 are high level.

The first decision unit 450 includes NOR gates 451, 452, 456, 457 and NAND gates 453, 454, 455. The NOR gate 451 performs a NOR operation on the group comparison signals GCS31, GCS32. The NOR gate 452 performs a NOR operation on the group comparison signals GCS33, GCS34. The NAND gate 455 performs a NAND operation on the group comparison signals GCS41, GCS42. The NAND gate 454 perform is a NAND operation on the group comparison signals GCS43, GCS43. The NAND gate 453 performs a NAND operation on outputs of the NOR gates 451, 452. The NOR gate 456 performs a NOR operation on outputs of the NAND gates 454, 455. The NOR gate 457 performs a NOR operation on outputs of the NAND gate 453 and the NOR gate 453. Therefore, first decision unit 450 provide a first decision signal DS1 which are enabled when all of the third group comparison signals GCS31, GCS32, GCS33, GCS34 are high level and at least one of the fourth group comparison signals GCS41, GCS42, GCS43, GCS44 is high level.

The second decision unit 460 includes NAND gates 461, 462, 463, 464. 465, 466, 467, 468, 469. The NAND gate 461 performs a NAND operation on corresponding intermediate decision signals IDS31, IDS41. The NAND gate 462 performs a NAND operation on corresponding intermediate decision signals IDS32, IDS42. The NAND gate 463 performs a NAND operation on corresponding intermediate decision signals IDS33, IDS43. The NAND gate 464 performs a NAND operation on corresponding intermediate decision signals IDS34, IDS44. The NAND gate 465 performs a NAND operation on corresponding intermediate decision signals IDS35, 1DS45. The NAND gate 466 performs a NAND operation on corresponding intermediate decision signals IDS36, IDS46. The NAND gate 467 performs a NAND operation on outputs of the NAND gates 461, 462, 463. The NAND gate 468 performs a NAND operation on outputs of the NAND gates 464, 465, 466. The NAND gate 469 performs a NAND operation on outputs of the NAND gates 467, 468 to provide a second decision signal DS2. Therefore, the second decision unit 360 provides the second decision signal DS2 which is enabled when both of at least one pair of corresponding pairs IDS31, IDS41, corresponding pairs IDS32, IDS42, corresponding pairs IDS33, IDS43, corresponding pairs IDS34, IDS44, corresponding pairs IDS35, IDS45 and corresponding pairs IDS36, IDS46 of the third intermediate decision signals IDS31, IDS32, IDS33, IDS34, IDS35, IDS36 and the fourth intermediate decision signals IDS41, IDS42, IDS43, IDS44, IDS45, IDS46 are high level.

The inversion signal output unit 470 includes a NOR gate 471 and an inverter 472. The NOR gate 471 performs a NOR operation on the first and second decision signals DS1, DS2. The inverter 472 inverts an output of the NOR gate 471 to provide the inversion control signal INCTL1. That is, the inversion signal output unit 470 provides the inversion control signal INCTL1 which is enabled when at least one of the first and second decision signals DS1, DS2 is high level.

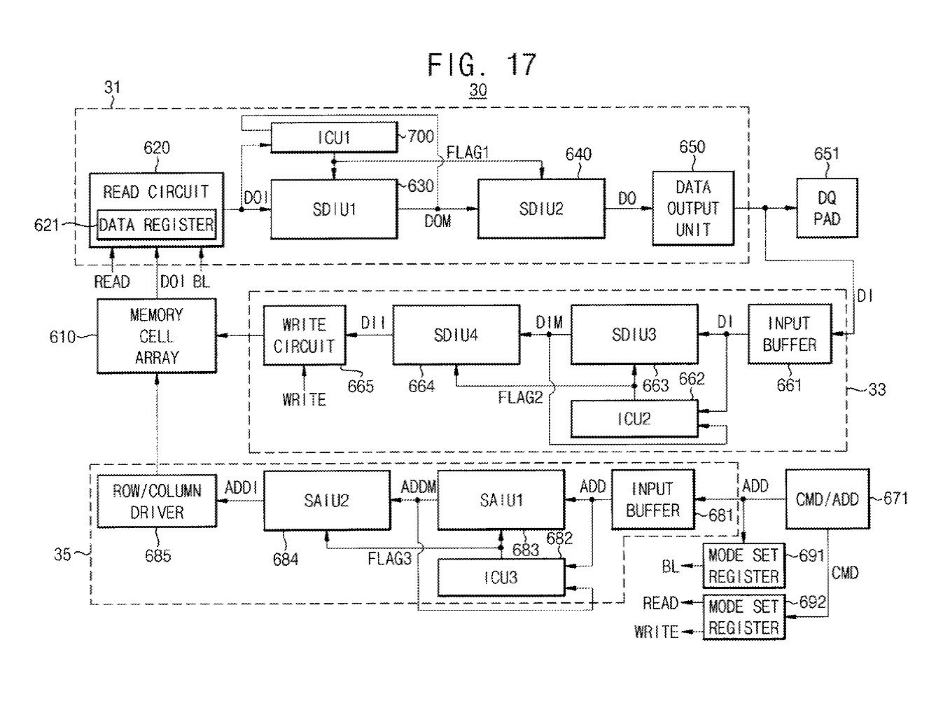

FIG. 15 is block diagram illustrating a memory controller according to an exemplary embodiment.

Referring to FIG. 15, a memory controller 20 includes a data register 510, an inversion control unit 520, a selective data inversion unit 530, a flag output unit 540, a data output unit 550, an input buffer unit 560, a command output unit 270 and an address output unit 580.

The data register 510 stores internal input data DII from a central processing unit. The internal input data DII stored in the data register 510 may be continuously (or sequentially) output to the selective data inversion unit 530.

The inversion control unit 520 generates an inversion control signal INCTL2 that determines whether the internal input data DII that is continuously input to the selective data inversion unit 530 is inverted or not.

The inversion control unit 520 divides a number of bit changes between corresponding bits of a current internal input data DII and a previous input data DI immediately preceding the current internal input data DII into a plurality of groups, determines the number of bit changes in each group, and provides the inversion control signal INCTL2 indicating whether the number of bit changes is greater than half of data width of the current internal input data DII. The inversion control unit 520 may be substantially the same as the inversion control unit 200 described with reference to FIGS. 4 to 6. For example, the inversion control unit 520 may provide to the selective data inversion unit 530 the inversion control signal INCTL2 with a high level, when the number of bit changes in each group is greater than the data width of the internal input data DII. In addition, the inversion control unit 520 may provide to the selective data inversion unit 530 the inversion control signal INCTL2 with a low level, when the number of bit changes in each group is not greater than the data width of the internal input data DII.

The selective data inversion unit 530 selectively either inverts or maintains (non-inverts) the current internal input data DII continuously provided from the data register 510 in response to the inversion control signal INCTL2 to provide the input data DI continuously. For example, the selective data inversion unit 530 inverts the current internal input data DII continuously provided from the data register 510 in response to the inversion control signal INCTL2 to provide the input data DI continuously when the inversion control signal INCTL2 is a high level. In addition, the selective data inversion unit 530 maintains the current internal input data DII continuously provided from the data register 510 in response to the inversion control signal INCTL2 to provide the input data DI continuously when the inversion control signal INCTL2 is a low level.

The flag output unit 540 may output a flag signal FLAG2 indicating whether the input data DI is inverted or not in response to the inversion control signal INCTL2. For example, the flag signal FLAG2 may indicate that the input data DI is inverted when the flag signal FLAG2 has a high level and may indicate that the input data DI has not been inverted when the flag signal FLAG2 has a low level.

The data output unit 550 may drive DQ pads 551 according to LVCMOS signaling based on the input data DI continuously output from the selective data inversion unit 530.

The input buffer unit 560 may buffer output data DO continuously transmitted from a memory device. The buffered output data DO may be used in a circuit block included in the memory controller 20 or input to an external cache memory or the central processing unit.

The command output unit 570 may provide command signal CMD to a semiconductor memory device in response to a signal input from the central processing unit.

The address output unit 580 provides address signal ADD to a semiconductor memory device in response to a signal input from the central processing unit.

FIG. 16 is a block diagram illustrating a memory system according to an exemplary embodiment.

Referring to FIG. 16, a memory system 600 includes the semiconductor memory device 10 of FIG. 1 and the memory controller 20 of FIG. 15.

The memory controller 20 may provide the command signal CMD and the address signal ADD. The memory controller 20 exchanges the data DATA and the flag signal FLAG with the semiconductor memory device 10.

The data read operation of the semiconductor memory device 10 will now be explained. In a read mode, the semiconductor memory device 10 divides a number of bit changes between corresponding bits of a current internal output data and a previous output data immediately preceding the current internal output data into a plurality of groups, determines the number of bit changes in each group, and inverts the current internal output data to provide the output data DATA when the number of bit changes between corresponding bits is greater than a data width of the current internal output data. The output data DATA is transmitted to the memory controller 10 through data bus with the flag signal FLAG indicating the inversion of the output data DATA.

The data write operation of the semiconductor memory device 10 will now be explained. In a write mode, the memory controller 20 divides a number of bit changes between corresponding bits of a current internal input data and a previous input data immediately preceding the current internal input data into a plurality of groups, determines the number of bit changes in each group, and inverts the current internal input data to provide the input data DATA when the number of bit changes between corresponding bits is greater than a data width of the current internal input data. The input data DATA is transmitted to the semiconductor memory device 20 through the data bus with the flag signal FLAG indicating the inversion of the input data DATA. The write circuit 170 in FIG. 1 receives the input data DATA and the flag signal FLAG and writes the input data DATA being inverted or non-inverted to the memory cell array 110 in FIG. 1 in response to the flag signal FLAG.

FIG. 17 is block diagram illustrating a semiconductor memory device according to an exemplary embodiment.

Referring to FIG. 17, a semiconductor memory device 30 includes a memory cell array 610, a read circuit unit 31, a write circuit unit 33, an address circuit unit 35, a mode set register 691 and a command decoder 692.

The read circuit unit 31 includes a read circuit 620, an inversion control unit (ICU) 700, first and second selective data inversion units (SDIU) 630, 640 and a data output unit 650. The write circuit unit 33 includes an input buffer unit 661, an inversion control unit 663, first and second selective data inversion units 663, 664 and a write circuit 665. The address circuit unit 35 includes an input buffer unit 681, an inversion control unit 682, first and second selective address inversion units (SAM) 683, 684, and a row/column driver 685.

The read circuit 620 includes a data register 621 and a data read operation circuit of the semiconductor memory device 30 (for example, a sense amplifier).

The read circuit 620 may perform a burst read operation that reads a predetermined number of internal output data DOI stored in the memory cell array 610 in parallel (or simultaneously) in response to a read signal READ and a burst length signal BL and may store the internal output data DOI read in parallel in the data register 621. For example, the data width of the internal output data DOI may be x8 and the number of internal output data DOI read in parallel may be 4 when the burst length signal BL signal indicates 4. The internal output data DOI stored in the data register 621 may be continuously (or sequentially) output to the selective data inversion unit 630.

The inversion control unit 700 generates a first flag signal FLAG1 determining whether the internal output data DOI that is continuously input to the first selective data inversion unit 630 is inverted or not.

The inversion control unit 700 divides a number of bit changes between corresponding bits of a current internal output data DOI and a previous intermediate output data DOM immediately preceding the current internal output data DOI into a plurality of groups, determines the number of hit changes in each group, and provides the first flag signal FLAG1 indicating whether the number of bit changes is greater than half of data width of the current internal output data DOI. For example, the inversion control unit 700 may provide to the first and second selective data inversion units 630, 640 the first flag signal FLAG1 with a high level, when the number of bit changes in each group is greater than the data width of the internal output data DOI. In addition, the inversion control unit 700 may provide to the first and second selective data inversion units 630, 640 the first flag signal FLAG1 with a low level, when the number of bit changes in each group is not greater than the data width of the internal output data DOI.

The first selective data inversion unit 630 selectively either inverts or maintains (non-inverts) the current internal output data DOI continuously provided from the memory cell array 610 in response to the first flag signal FLAG1 to provide the intermediate output data DOM continuously to the second selective data inversion unit 640.

The second selective data inversion unit 640 inverts or maintains the intermediate output data DOM continuously provided from first selective data inversion unit 630 in response to the first flag signal FLAG1 to provide the output data DO continuously. For example, the second selective data inversion unit 640 inverts the intermediate output data DOM when the first flag signal FLAG1 is high level. In addition, the second selective data inversion unit 640 non-inverts the intermediate output data DOM when the first flag signal FLAG1 is low level. As a result, bits of the output data DO are same as corresponding bits of the internal output data DOI.

The data output unit 650 may drive DQ pads 651 according to LVCMOS signaling based on the output data DO continuously output from the second selective data inversion unit 640.

That is, the read circuit unit 31 may reduce current consumption due to data toggling on a read data bus between the read circuit 620 and the data output unit 650 by inverting the internal output data DOI twice or non-inverting the internal output data DOI in the inversion control unit 700 and the first and second selective data inversion units 630, 640. That is, the read circuit unit 31 may perform on-chip data bit inversion (DBI) on the read data bus between the read circuit 620 and the data output unit 650 by including the inversion control unit 700 and the first and second selective data inversion units 630, 640.

The input buffer unit 661 may buffer input data DI continuously transmitted from a memory controller. When the data width of the input data DI is x8, for example, the input buffer unit 661 may include eight input buffers corresponding to the data width of the input data DI.

The inversion control unit 662 generates a second flag signal FLAG2 determining whether the input data DI that is continuously input to the first selective data inversion unit 663 is inverted or not.

The inversion control unit 663 divides a number of bit changes between corresponding bits of a current input data DI and a previous intermediate input data DIM immediately preceding the current input data DI into a plurality of groups, determines the number of bit changes in each group, and provides the second flag signal FLAG2 indicating whether the number of bit changes is greater than half of data width of the current input data DI. For example, the inversion control unit 662 may provide to the first and second selective data inversion units 663, 664 the second flag signal FLAG2 with a high level, when the number of bit changes in each group is greater than the data width of the input data DI. In addition, the inversion control unit 662 may provide to the first and second selective data inversion units 663, 664 the second flag signal FLAG2 with a low level, when the number of bit changes in each group is not greater than the data width of the input data DI.

The first selective data inversion unit 663 selectively either inverts or maintains the current input data DI continuously provided from input buffer unit 661 in response to the second flag signal FLAG2 to provide the intermediate input data DIM continuously to the second selective data inversion unit 664.

The second selective data inversion unit 664 selectively either inverts or maintains the intermediate input data DIM continuously provided from first selective data inversion unit 664 in response to the second flag signal FLAG2 to provide the internal input data DII continuously. For example, the second selective data inversion unit 664 inverts the intermediate input data DIM when the second flag signal FLAG2 is a high level. In addition, the second selective data inversion unit 664 non-inverts the intermediate input data DIM when the second flag signal FLAG2 is a low level. As a result, bits of the internal input data DII are the same as corresponding bits of the input data DII.

The write circuit 665 may include a circuit related to a data write operation of the semiconductor memory device 30 (for example, an input driver). The write circuit 665 may perform a burst write operation that writes internal input data DII output from the second selective data inversion unit 664.

That is, the write circuit unit 33 may reduce current consumption due to data toggling on a write data bus between the input buffer unit 661 and the write circuit 665 by inverting the input data DI twice or non-inverting the input data DI in the inversion control unit 662 and the first and second selective data inversion units 663 and 664. That is, the write circuit unit 33 may perform on-chip data bit inversion (DBI) on the write data bus between the input buffer unit 661 and the write circuit 665 by including the inversion control unit 662 and the first and second selective data inversion units 663, 664.

The mode register set 691 may generate the burst length signal BL in response to an address signal ADD provided by the memory controller through command/address pads 671. The command decoder 190 may generate the read signal READ and the write signal WRITE synchronized with the clock signal in response to a command signal CMD provided by the memory controller through the command/address pads 671.

The input buffer unit 681 may buffer the address signal ADD. The inversion control unit 682 generates a third flag signal FLAG3 determining whether the address signal ADD that is continuously input to the first selective address inversion unit 683 is inverted or not.

The inversion control unit 683 divides a number of bit changes between corresponding bits of a current address signal ADD and a previous intermediate address signal ADDM immediately preceding the current address signal ADD into a plurality of groups, determines the number of bit changes in each group, and provides the third flag signal FLAG3 indicating whether the number of bit changes is greater than half of address width of the current address signal ADD. For example, the inversion control unit 682 may provide to the first and second selective address inversion units 683, 684 the third flag signal FLAG3 with a high level, when the number of bit changes in each group is greater than the address width of the address signal ADD. In addition, the inversion control unit 682 may provide to the first and second selective address inversion units 683, 684 the third flag signal FLAG3 with a low level, when the number of bit changes in each group is not greater than the address width of the address signal ADD.

The first selective address inversion unit 683 selectively either inverts or maintains (non-inverts) the current address signal ADD continuously provided from input buffer unit 681 in response to the third flag signal FLAG3 to provide the intermediate address signal ADDM continuously to the second selective address inversion unit 684.

The second selective address inversion unit 684 selectively either inverts or maintains the intermediate address signal ADDM continuously provided from first selective address inversion unit 684 in response to the third flag signal FLAG3 to provide the address signal ADDI continuously. For example, the second selective address inversion unit 684 inverts the intermediate address signal ADDM when the third flag signal FLAG3 is a high level. In addition, the second selective address inversion unit 684 non-inverts the intermediate address signal ADDM when the third flag signal FLAG3 is a low level. As a result, bits of the internal address signal ADDI are the same as corresponding bits of the address signal ADD.

The row/column driver 685 accesses corresponding memory cells in the memory cell array 610 in response to the internal address signal ADDI.

That is, the address circuit unit 35 may reduce current consumption due to address toggling on an address bus between the input buffer unit 681 and the row/column driver 685 by inverting the address signal ADD twice or non-inverting the address signal ADD in the inversion control unit 682 and the first and second selective address inversion units 683, 684. That is, the address circuit unit 35 may perform on-chip address bit inversion (ABI) on the address bus between the input buffer unit 681 and the row/column driver 685 by including the inversion control unit 682 and the first and second selective address inversion units 683, 684.

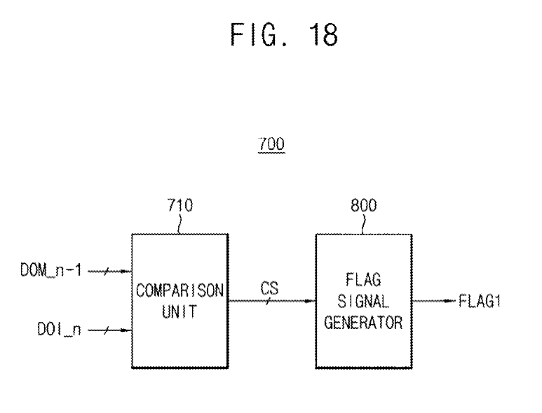

FIG. 18 is a block diagram illustrating an example of the inversion control unit in FIG. 17.

Referring to FIG. 18, the inversion control unit 700 includes a comparison unit 710 and a flag signal generator 800.

The comparison unit 710 compares the corresponding bits of the current internal output data DOI_n and the previous intermediate output data DOM_n−1 to provide a plurality of comparison signals CS and each of the comparison signals CS indicates a change of the corresponding bits of the current internal output data DOI_n and the previous intermediate output data DOM_n−1. The flag signal generator 800 receives the comparison signals CS, divides the comparison signals CS into a plurality of groups by predetermined bits (for example, two bits) and determines the number of bit changes in each group to provide the flag signal FLAG1.

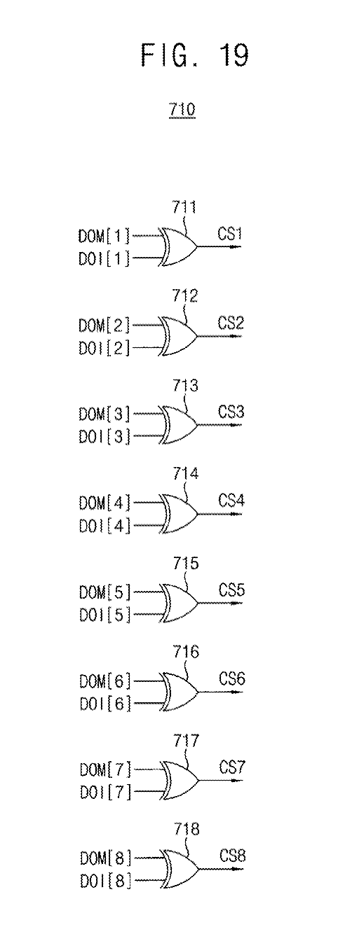

FIG. 19 illustrates an example of the comparison unit in FIG. 18.

Referring to FIG. 19, the comparison unit 710 may include a plurality of exclusive OR gates 711, 712, 713, 714, 715, 716, 717, 718.

The exclusive OR gate 711 performs an exclusive OR operation on current internal output data DOI[1] and the previous output data DOM[1] to provide a comparison signal CS1. The exclusive OR gate 712 performs an exclusive OR operation on current internal output data DOI[2] and the previous output data DOM[2] to provide a comparison signal CS2. The exclusive OR gate 713 performs an exclusive OR operation on current internal output data DOI[3] and the previous output data DOM[3] to provide a comparison signal CS3. The exclusive OR gate 714 performs an exclusive OR operation on current internal output data DOI[4] and the previous output data DOM[4] to provide a comparison signal CS4. The exclusive OR gate 715 performs an exclusive OR operation on current internal output data DOI[5] and the previous output data DOM[5] to provide a comparison signal CS5. The exclusive OR gate 716 performs an exclusive OR operation on current internal output data DOI[6] and the previous output data DOM[6] to provide a comparison signal CS6. The exclusive OR gate 717 performs an exclusive OR operation on current internal output data DOI[7] and the previous output data DOM[7] to provide a comparison signal CS7. The exclusive OR gate 718 performs an exclusive OR operation on current internal output data DOI[8] and the previous output data DOM[8] to provide a comparison signal CS8. Therefore, each of the comparison signals CS1, CS2, CS3, CS4, CS5, CS6, CS7, CS8 may have a high level when the corresponding bits of the current internal output data DOI_n and the previous output data DOM_n−1 are changed and may have a low level when the corresponding bits of the current internal output data DOI n and the previous output data DOM_n−1 are not changed.

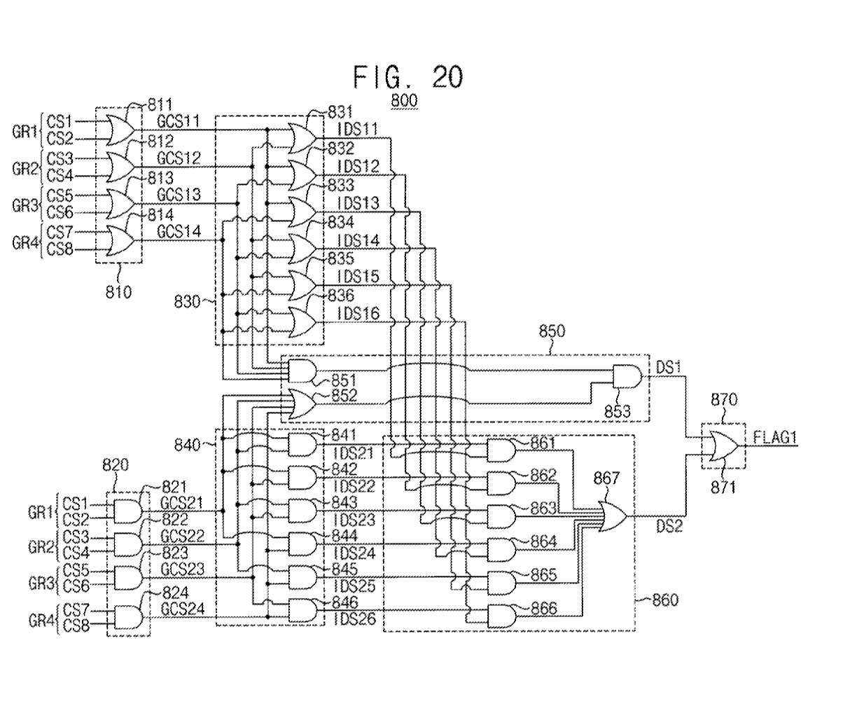

FIG. 20 illustrates an example of the flag signal generator in FIG. 18.

Referring to FIG. 20, a flag signal generator 800 may include a first group decision unit 810, a second group decision unit 820, a first intermediate decision unit 830, a second intermediate decision unit 840, a first decision unit 850, a second decision unit 860 and an inversion control signal output unit 870.

A group GR1 includes two comparison signals CS1, CS2, a group GR2 includes two comparison signals CS3, CS4, a group GR3 includes two comparison signals CS5, CS6, and a group GR4 includes two comparison signals CS7, CS8. That is, each of the groups GR1, GR2, GR3, GR4 includes two bits of the comparison signals CSI, CS2, CS3, CS4, CS5, CS6, CS7, CS8.

The first group decision unit 810 includes OR gates 811, 812, 813, 814. The OR gate 811 performs an OR operation on the comparison signals CSI, CS2 to provide a group comparison signal GCS11. The OR gate 812 performs an OR operation on the comparison signals CS3, CS4 to provide a group comparison signal GCS12. The OR gate 813 performs an OR operation on the comparison signals CS5, CS6 to provide a group comparison signal GCS13. The OR gate 814 performs an OR operation on the comparison signals CS7, CS8 to provide a group comparison signal GCS14. Therefore, each of the first group comparison signals GCS11, GCS12, GCS13, GCS14 may have a high level when at least one of each two bits of the comparison signals CS1, CS2, the comparison signals CS3, CS4, the comparison signals CS5, CS6 and the comparison signals CS7, CS8 has a high level. That is, each of the first group comparison signals GCS11, GCS12, GCS13, GCS14 may be enabled when at least one of each two bits of the comparison signals CS1, CS2, the comparison signals CS3, CS4, the comparison signals CS5, CS6 and the comparison signals CS7, CS8 indicates that the corresponding bits are changed.

The second group decision unit 820 includes AND gates 821, 822, 823, 824. The AND gate 821 performs an AND operation on the comparison signals CS1, CS2 to provide a group comparison signal GCS21. The AND gate 822 performs an AND operation on the comparison signals CS3, CS4 to provide a group comparison signal GCS22. The AND gate 823 performs an AND operation on the comparison signals CS5, CS6 to provide a group comparison signal GCS23. The AND gate 824 performs an AND operation on the comparison signals CS7, CS8 to provide a group comparison signal GCS24. Therefore, each of the second group comparison signals GCS21, GCS22, GCS23, GCS24 may have a high level when both of each two bits of the comparison signals CS1, CS2, the comparison signals CS3, CS4, the comparison signals CS5, CS6 and the comparison signals CS7 and CS8 has a high level. That is, each of the second group comparison signals GCS21, GCS22, GCS23, GCS24 may be enabled when both of each two bits of the comparison signals CS1, CS2, the comparison signals CS3, CS4, the comparison signals CS5, CS6 and the comparison signals CS7, CS8 indicates that the corresponding bits are changed.

The first intermediate decision unit 830 includes OR gates 831, 832, 833, 834, 835, 836. The OR gate 831 performs an OR operation on the group comparison signals GCS11, GCS12 to provide an intermediate decision signal IDS11. The OR gate 832 performs an OR operation on the group comparison signals GCS11, GCS13 to provide an intermediate decision signal IDS12. The OR gate 833 performs an OR operation on the group comparison signals GCS11, GCS14 to provide an intermediate decision signal IDS13. The OR gate 834 performs an OR operation on the group comparison signals GCS12, GCS13 to provide an intermediate decision signal IDS14. The OR gate 835 performs an OR operation on the group comparison signals GCS12, GCS14 to provide an intermediate decision signal IDS15. The OR gate 836 performs an OR operation on the group comparison signals GCS13, GCS14 to provide an intermediate decision signal IDS16. That is, first intermediate decision unit 830 provides the first intermediate decision signals IDS11, IDS12, IDS13, IDS14, IDS15, IDS16, and each of the first intermediate decision signals IDS11, IDS12, IDS13, IDS14, IDS15, IDS16 is enabled when at least one of non-overlapped two of the first group comparison signals GCS11, GCS12, GCS13, GCS14 is high level.

The second intermediate decision unit 840 includes AND gates 841, 842, 843, 844, 845, 846. The AND gate 841 performs an AND operation on the group comparison signals GCS21, GCS22 to provide an intermediate decision signal IDS21. The AND gate 842 performs an AND operation on the group comparison signals GCS21, GCS23 to provide an intermediate decision signal IDS22. The AND gate 843 performs an AND operation on the group comparison signals GCS21, GCS24 to provide an intermediate decision signal IDS23. The AND gate 844 performs an AND operation on the group comparison signals GCS22, GCS23 to provide an intermediate decision signal IDS24. The AND gate 845 performs an AND operation on the group comparison signals GCS22, GCS24 to provide an intermediate decision signal IDS25. AND gate 846 performs an AND operation on the group comparison signals GCS23, GCS24 to provide an intermediate decision signal IDS26. That is, second intermediate decision unit 840 provides the second intermediate decision signals IDS21, IDS22, IDS23, IDS24, IDS25, IDS26, and each of the second intermediate decision signals IDS21, IDS22, IDS23, IDS24, IDS25, IDS26 is enabled when both of non-overlapped two of the second group comparison signals GCS21, GCS22, GCS23, GCS24 are high level.

The first decision unit 850 includes AND gates 851, 853 and OR gate 852. The AND gate 851 performs an AND operation on the first group comparison signals GCS11, GCS12, GCS13, GCS14. The OR gate 852 performs an OR operation on the second group comparison signals GCS21, GCS22, GCS23, GCS24. The AND gate 853 performs an AND operation on outputs of the AND gate 851 and the OR gate 852 to provide a first decision signal DS1. Therefore, the first decision unit 850 provides a first decision signal DS1 which are enabled when all of the first group comparison signals GCS11, GCS12, GCS13, GCS14 are high level and at least one of the second group comparison signals GCS21, GCS22, GCS23, GCS24 is high level.

The second decision unit 860 includes AND gates 861, 862, 863, 864, 865, 866 and OR gate 867. The AND gate 861 performs an AND operation on corresponding intermediate decision signals IDS11, IDS21. The AND gate 862 performs an AND operation on corresponding intermediate decision signals IDS12, IDS22. The AND gate 863 performs an AND operation on corresponding intermediate decision signals IDS13, IDS23. The AND gate 864 performs an AND operation on corresponding intermediate decision signals IDS14, IDS24. The AND gate 865 performs an AND operation on corresponding intermediate decision signals IDS15, IDS25. The AND gate 866 performs an AND operation on corresponding intermediate decision signals IDS16, IDS26. The OR gate 867 performs an OR operation on outputs of the AND gates 861, 862, 863, 864, 865, 866 to provide a second decision signal DS2. Therefore, the second decision unit 860 provides the second decision signal DS2 which is enabled when both of at least one pair of corresponding pairs IDS11, IDS21, corresponding pairs IDS12, IDS22, corresponding pairs IDS13, IDS23, corresponding pairs IDS14, IDS24, corresponding pairs IDS15, IDS25 and corresponding pairs IDS16, IDS26 of the first intermediate decision signals IDS11, IDS12, IDS13, IDS14, IDS15, IDS16 and the second intermediate decision signals IDS21, IDS22, IDS23, IDS24, IDS25, IDS26 are high level.

The inversion signal output unit 870 includes an OR gate 871. The OR gate 871 performs an OR operation on the first and second decision signals DS1, DS2 to provide the flag signal FLAG1. That is, the inversion signal output unit 870 provides the flag signal FLAG1 which is enabled when at least one of the first and second decision signals DS1, DS2 is high level.

The inversion control units 662, 682 may have substantially same configuration as the inversion control unit 700.

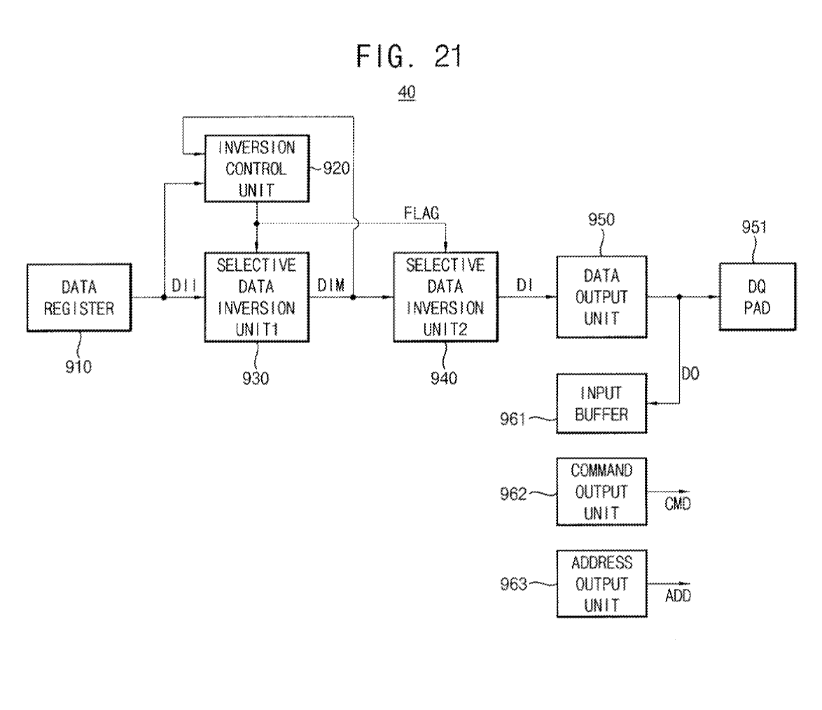

FIG. 21 is block diagram illustrating a memory controller according to an exemplary embodiment.

Referring to FIG. 21, a memory controller 40 includes a data register 910, an inversion control unit 920, first and second selective data inversion units 930, 940, a data output unit 950, an input buffer unit 960, a command output unit 970 and an address output unit 980.

The data register 910 stores internal input data DII from a central processing unit. The internal input data DII stored in the data register 910 may be continuously (or sequentially) output to the first selective data inversion unit 930.

The inversion control unit 920 generates a flag signal FLAG determining whether the internal input data DII that is continuously input to the first selective data inversion unit 930 is inverted or not.

The inversion control unit 920 divides a number of bit changes between corresponding bits of a current internal input data DII and a previous input data DI immediately preceding the current internal input data DII into a plurality of groups, determines the number of bit changes in each group, and provides with the first and second selective data inversion units 930, 940 the flag signal FLAG indicating whether the number of bit changes is greater than half of data width of the current internal input data DII. The inversion control unit 920 may be substantially same as the inversion control unit 700 described with reference to FIGS. 18 to 20. For example, the inversion control unit 920 may provide to the first and second selective data inversion units 930, 940 the flag signal FLAG with a high level, when the number of bit changes in each group is greater than the data width of the internal input data DII. In addition, the inversion control unit 920 may provide to the first and second selective data inversion units 930, 940 the flag signal FLAG with a low level, when the number of bit changes in each group is not greater than the data width of the internal input data DII.

The first selective data inversion unit 930 selectively either inverts or maintains (non-inverts) the current internal input data DII continuously provided from the data register 910 in response to the flag signal FLAG to provide the intermediate input data DIM continuously to the second selective data inversion unit 940.

The second selective data inversion unit 940 selectively either inverts or maintains (non-inverts) the intermediate input data DIM continuously provided from first selective data inversion unit 930 in response to the flag signal FLAG to provide the input data DI continuously. For example, the second selective data inversion unit 940 inverts the intermediate input data DIM when the flag signal FLAG is high level. In addition, the second selective data inversion unit 940 non-inverts the intermediate input data DIM when the flag signal FLAG is low level. As a result, bits of the input data DI are the same as corresponding bits of the internal input data DII.

The data output unit 950 may drive DQ pads 951 according to LVCMOS signaling based on the input data DI continuously output from the second selective data inversion unit 940.

The input buffer unit 961 may buffer output data DO continuously transmitted from a memory device. The buffered output data DO may be used in a circuit block included in the memory controller 40 or input to an external cache memory or the central processing unit.

The command output unit 962 provides command signal CMD to the semiconductor memory device in response to a signal input from the central processing unit.

The address output unit 963 provides address signal ADD to the semiconductor memory device in response to a signal input from the central processing unit.

That is, the memory controller 40 may reduce current consumption due to data toggling on a data bus between the data register 910 and the data output unit 950 by inverting the internal input data DII twice or non-inverting the internal input data DII in the inversion control unit 920 and the first and second selective data inversion units 930, 940. That is, the memory controller 40 may perform on-chip data bit inversion (DBI) on the data bus between the data register 910 and the data output unit 950 by including inversion control unit 920 and the first and second selective data inversion units 930, 940.

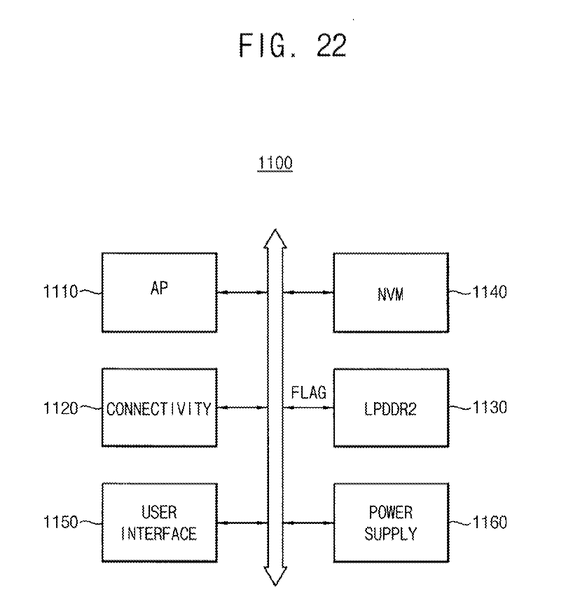

FIG. 22 is a block diagram illustrating a mobile system according to exemplary embodiments.

Referring to FIG. 22, a mobile system 1100 includes an application processor (AP) 1110, a connectivity unit 1120, a volatile memory device (LPDDR2) 1130, a nonvolatile memory (NVM) device 1140, a user interface 1150 and a power supply 1160. In an exemplary embodiment the mobile system 1100 may be a mobile phone, a smart phone, a personal digital assistant (PDA), a portable multimedia player (PMP), a digital camera, a music player, a portable game console, a navigation system, etc.

The application processor 1110 may execute applications, such as a web browser, a game application, a video player, etc. In an exemplary embodiment the application processor 1110 may include a single core or multiple cores. For example, the application processor 1110 may be a multi-core processor, such as a dual-core processor, a quad-core processor, a hexa-core processor, and the like. The application processor 1110 may include an internal or external cache memory.

The connectivity unit 1120 may perform wired or wireless communication with an external device. For example, the connectivity unit 1120 may perform Ethernet communication, near field communication (NFC), radio frequency identification (RFID) communication, mobile telecommunication, memory card communication, universal serial bus (USB) communication, etc. In an exemplary embodiment connectivity unit 1120 may include a baseband chipset that supports communications, such as global system for mobile communications (GSM), general packet radio service (GPRS), wideband code division multiple access (WCDMA), high speed downlink/uplink packet access (HSxPA), etc.

The volatile memory device 1130 may store data processed by the application processor 1110, or may operate as a working memory. For example, the volatile memory device 1130 may be a dynamic random access memory, such as DDR SDRAM, LPDDR SDRAM, GDDR SDRAM, RDRAM, etc., or may be any volatile memory device that requires a refresh operation. The volatile memory devices 1130 may selectively either invert or non-invert input data or output data in response to a flag signal from the application processor 1110.

The nonvolatile memory device 1140 may store a boot image for booting the mobile system 1100. For example, the nonvolatile memory device 1140 may be an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The user interface 1150 may include at least one input device, such as a keypad, a touch screen, etc., and at least one output device, such as a speaker, a display device, etc. The power supply 1160 may supply a power supply voltage to the mobile system 1100. In an exemplary embodiment the mobile system 1100 may further include a camera image processor (CIS), and/or a storage device, such as a memory card, a solid state drive (SSD), a hard disk drive (HDD), a CD-ROM, etc.

In an exemplary embodiment the mobile system 1100 and/or components of the mobile system 1100 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

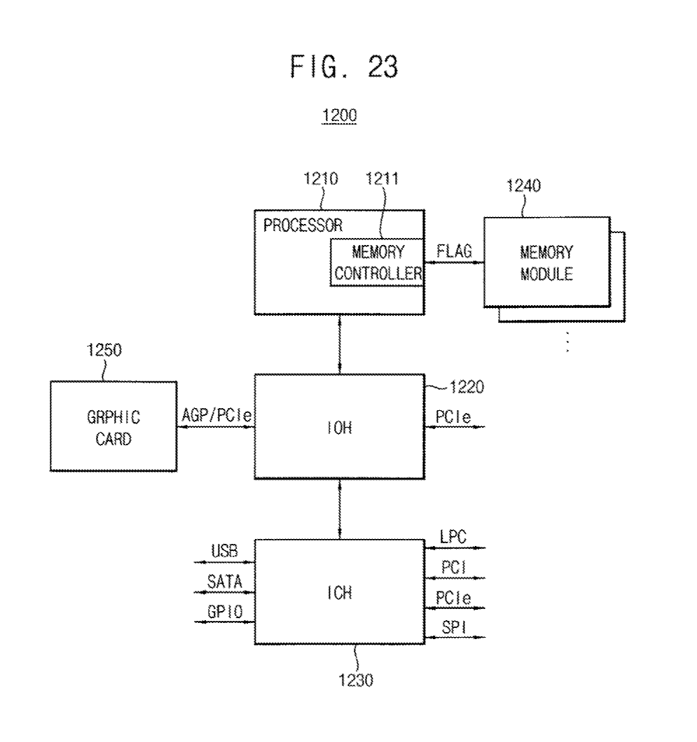

FIG. 23 is a block diagram illustrating a computing system according to an exemplary embodiment.

Referring to FIG. 23, a computing system 1200 includes a processor 1210, an input/output hub (IOH) 1220, an input/output controller hub (ICH) 1230, at least one memory module 1240 and a graphics card 1250. In an exemplary embodiment the computing system 1200 may be a personal computer (PC), a server computer, a workstation, a laptop computer, a mobile phone, a smart phone, a personal digital assistant (PDA), a portable multimedia player (PMP), a digital camera), a digital television, a set-top box, a music player, a portable game console, a navigation system, etc.

The processor 1210 may perform various computing functions, such as executing specific software for performing specific calculations or tasks. For example, the processor 1210 may be a microprocessor, a central process unit (CPU), a digital signal processor, or the like. In an exemplary embodiment the processor 1210 may include a single core or multiple cores. For example, the processor 1210 may be a multi-core processor, such as a dual-core processor, a quad-core processor, a hexa-core processor, etc. Although FIG. 23 illustrates the computing system 1200 including one processor 1210, in an exemplary embodiment the computing system 1200 may include a plurality of processors. The processor 1210 may include an internal or external cache memory.

The processor 1210 may include a memory controller 1211 for controlling operations of the memory module 1240. The memory controller 1211 included in the processor 1210 may be referred to as an integrated memory controller (IMC). A memory interface between the memory controller 1211 and the memory module 1240 may be implemented with a single channel including a plurality of signal lines, or may be implemented with multiple channels, to each of which at least one memory module 1240 may be coupled. In an exemplary embodiment the memory controller 1211 may be located inside the input/output hub 1220, which may be referred to as memory controller hub (MCH).

The memory module 1240 may include a plurality of volatile memory devices that store data provided from the memory controller 1211. The volatile memory devices may selectively either invert or non-invert input data or output data in response to a flag signal FLAG to/from the processor 1210.

The input/output hub 1220 may manage data transfer between processor 1210 and devices, such as the graphics card 1250. The input/output hub 1220 may be coupled to the processor 1210 via various interfaces. For example, the interface between the processor 1210 and the input/output hub 1220 may be a front side bus (FSB), a system bus, a HyperTransport, a lightning data transport (LDT), a QuickPath interconnect (QPI), a common system interface (CSI), etc. Although FIG. 23 illustrates the computing system 1200 including one input/output hub 1220, in an exemplary embodiment the computing system 1200 may include a plurality of input/output hubs. The input/output hub 1220 may provide various interfaces with the devices. For example, the input/output hub 1220 may provide an accelerated graphics port (AGP) interface, a peripheral component interface-express (PCIe), a communications streaming architecture (CSA) interface, etc.

The graphics card 1250 may be coupled to the input/output hub 1220 via AGP or PCIe. The graphics card 1250 may control a display device (not shown) for displaying an image. The graphics card 1250 may include an internal processor for processing image data and an internal memory device. In an exemplary embodiment the input/output hub 1220 may include an internal graphics device along with or instead of the graphics card 1250 outside the graphics card 1250. The graphics device included in the input/output hub 1220 may be referred to as integrated graphics. Further, the input/output hub 1220 including the internal memory controller and the internal graphics device may be referred to as a graphics and memory controller hub (GMCH).

The input/output controller hub 1230 may perform data buffering and interface arbitration to efficiently operate various system interfaces. The input/output controller hub 1230 may be coupled to the input/output hub 1220 via an internal bus, such as a direct media interface (DMI), a hub interface, an enterprise Southbridge interface (ESI), PCIe, etc. The input/output controller hub 1230 may provide various interfaces with peripheral devices. For example, the input/output controller hub 1230 may provide a universal serial bus (USB) port, a serial advanced technology attachment (SATA) port, a general purpose input/output (GPIO), a low pin count (LPC) bus, a serial peripheral interface (SPI), PCI, PCIe, etc.

In an exemplary embodiment the processor 1210, the input/output hub 1220 and the input/output controller hub 1230 may be implemented as separate chipsets or separate integrated circuits. In other embodiments, at least two of the processor 1210, the input/output hub 1220 and the input/output controller hub 1230 may be implemented as a single chipset.

Therefore, according to various exemplary embodiments, current consumption and occupied circuit size may be reduced by inverting or non-inverting based on the comparison of corresponding bits of current data and previous data.

The present inventive concept may be applied to low-powered semiconductor memory devices and mobile systems requiring reduced circuit area and reduced power consumption.

Although various exemplary embodiments have been described, those skilled in the art will readily appreciate that many modifications are possible in the exemplary embodiments without materially departing from the novel teachings and advantages of the present inventive concept. Accordingly, all such modifications, as well as other exemplary embodiments, are intended to be included within the scope of the appended claims.

What is claimed is:

1. A semiconductor memory device comprising:
a selective data inversion unit configured to selectively either invert or maintain internal output data having a plurality of bits from a memory cell array to provide output data with a plurality of bits in response to an inversion control signal; and
an inversion control unit configured to divide a number of bit changes between corresponding bits of a current internal output data and a previous output data immediately preceding the current internal output data into a plurality of groups, configured to determine the number of bit changes in each group, and configured to provide the inversion control signal that indicates whether the number of bit changes is greater than half of data width of the current internal output data.

2. The semiconductor memory device of claim 1, wherein the selective data inversion unit is configured to invert the current internal output data to provide the output data when the inversion control signal indicates that the number of bit changes is greater than half of the data width of the current internal output data.

3. The semiconductor memory device of claim 1, wherein the selective data inversion unit is configured to maintain the current internal output data to provide the output data when the inversion control signal indicates that the number of bit changes is not greater than half of the data width of the current internal output data.

4. The semiconductor memory device of claim 1, wherein the inversion control unit comprises:
a comparison unit configured to compare corresponding bits of the current internal output data and the previous output data to provide a plurality of comparison signals, each comparison signal indicating a change of the corresponding bits; and
an inversion control signal generator configured to divide the plurality of comparison signals into the groups and configured to determine a number of bit changes in each group to provide the inversion control signal.

5. The semiconductor memory device of claim 4,
wherein each of the groups includes two bits of the comparison signals, and
wherein the inversion control signal generator comprises:
a first group decision unit configured to provide a plurality of first group comparison signals which are enabled when at least one of each two bits of the comparison signals indicates that the corresponding bits are changed;
a second group decision unit configured to provide a plurality of second group comparison signals which are enabled when both of each two bits of the comparison signals indicate that the corresponding bits are changed;
a first intermediate decision unit configured to provide a plurality of first intermediate decision signals, each first intermediate decision being enabled when at least one of non-overlapped two of the first group comparison signals is a high level;
a second intermediate decision unit configured to provide a plurality of second intermediate decision signals, each second intermediate decision signal being enabled when both of non-overlapped two of the second group comparison signals are a high level;
a first decision unit configured to provide a first decision signal which is enabled when all of the first group comparison signals are a high level and at least one of the second group comparison signals is a high level;
a second decision unit configured to provide a second decision signal which is enabled when both of at least one pair of corresponding pairs of the first intermediate decision signals and the second intermediate decision signals are a high level; and
an inversion control signal output unit configured to provide the inversion control signal which is enabled when at least one of the first and second decision signals is a high level.

6. The semiconductor memory device of claim 5, wherein the inversion control signal generator is configured to provide the enabled inversion control signal when one bit of the two bits in each of the groups is changed and the other bit of the two bits in only one of the groups is changed.

7. The semiconductor memory device of claim 5, wherein the inversion control signal generator is configured to provide the enabled inversion control signal when the two bits in only one of the groups are not changed and two bits in each of other groups other than the only one of the groups are changed.

8. The semiconductor memory device of claim 5, wherein the inversion control signal generator is configured to provide the enabled inversion control signal when the two bits in each of the groups are changed.

9. The semiconductor memory device of claim 1, furthering comprising a flag output unit configured to buffer the inversion control signal to provide a flag signal.

10. The semiconductor memory device of claim 1, furthering comprising a data output unit configured to provide the output data to a data pad.

11. A semiconductor memory device, comprising:
a memory cell array; and
a read circuit unit configured to perform on-chip data bit inversion (DBI) on internal output data having a plurality of bits from the memory cell array on a read data bus between the memory cell array and a data pad to provide output data with a plurality of bits to the data pad.

12. The semiconductor memory device of claim 11, wherein the read circuit unit comprises:
an inversion control unit configured to divide a number of bit changes between corresponding bits of a current internal output data and a previous intermediate output data immediately preceding the current internal output data into a plurality of groups, configured to determine a number of bit changes in each group, and configured to provide a flag signal indicating whether the number of bit changes is greater than half of data width of the current internal output data;
a first selective data inversion unit configured to selectively either invert or maintain the internal output data to provide the intermediate output data in response to the flag signal; and
a second selective data inversion unit configured to selectively either invert or maintain the intermediate output data to provide the output data in response to the flag signal.

13. The semiconductor memory device of claim 11, further comprising:
a write circuit unit configured to perform on-chip data bit inversion (DBI) on input data with a plurality of bits from the data pad on a write data bus between the data pad and a write circuit that writes data to the memory cell array, to provide internal input data to the write circuit, and
wherein the write circuit unit comprises:
an inversion control unit configured to divide a number of bit changes between corresponding bits of a current input data and a previous intermediate input data immediately preceding the current input data into a plurality of groups, configured to determine a number of bit changes in each group, and configured to provide a flag signal indicating whether the number of bit changes in each group is greater than half of data width of the current input data;
a first selective data inversion unit configured to selectively either invert or maintain the input data to provide intermediate input data in response to the flag signal; and
a second selective data inversion unit configured to selectively either invert or maintain the intermediate input data to provide the internal input data in response to the flag signal.

14. The semiconductor memory device of claim 11, further comprising:
an address circuit unit configured to perform on-chip address bit inversion (ABI) on an address signal having a plurality of bits from an address pad on an address bus between the address pad and a row/column driver which accesses the memory cell array, to provide an internal address signal to the row/column driver, and
wherein the address circuit unit comprises:
an inversion control unit configured to divide a number of bit changes between corresponding bits of a current address signal and a previous intermediate address signal immediately preceding the current address signal into a plurality of groups, configured to determine a number of bit changes in each group, and configured to provide a flag signal indicating whether the number of bit changes in each group is greater than half of address width of the current address signal;
a first selective data inversion unit configured to selectively either invert or maintain the address signal to provide an intermediate address signal in response to the flag signal; and
a second selective data inversion unit configured to selectively either invert or maintain the intermediate address signal to provide the internal address signal in response to the flag signal.
